(19) United States
(12) Patent Application Publication
(10) Pub. No.: US 2009/0119423 A1
(43) Pub. Date: May 7, 2009

(54) Transfer control device, LSI, and LSI package

(75) Inventors: Hidenori Matsuzaki, Kanagawa (JP); Tsutomu Sugawara, Kanagawa (JP); Takeshi Tomizawa, Kanagawa (JP); Tomoya Horiguchi, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/898,921

(22) Filed: Sep. 17, 2007

(30) Foreign Application Priority Data
Dec. 26, 2006 (JP) 2006-350437

(51) Int. Cl. G06F 13/14; G06F 13/36

(52) U.S. Cl. 710/35; 710/315

(57) ABSTRACT

A transfer control device is arranged between a bus and a bus interface. The transfer control device includes a bus connecting unit that is connected to plural signal lines of the bus, an interface connecting unit that is connected to plural signal lines of the bus interface, and a connection control unit that connects, when a defective signal line exists in the plural signal lines of the bus, a signal line corresponding to the defective signal line out of the plural signal lines of the bus interface and a signal line other than the defective signal line out of the plural signal lines of the bus.

### CROSS-REFERENCE TO RELATED APPLICATIONS

This application is based upon and claims the benefit of priority from the prior Japanese Patent Application No. 2006-350437, filed on Dec. 26, 2006; the entire contents of which are incorporated herein by reference.

### BACKGROUND OF THE INVENTION

1. Field of the Invention

The present invention relates to a transfer control device provided between a bus and a bus interface, and a Large-Scale Integration (LSI) and an LSI package including this transfer control device.

2. Description of the Related Art

Miniaturization technology allows a larger number of functional modules to be mounted on a single LSI. This is accompanied by an increasing demand for larger information-carrying capacity of buses connecting the functional modules. The larger information-carrying capacity tends to be realized through an increase in the number of signal lines employed by the bus.

While the miniaturization reduces the area of each functional module, the number of functional modules is increasing. As a result, the buses which connect the functional modules become longer relative to a mounted area of the functional modules.

As a result, the signal lines of the bus come to occupy a higher rate of the total area of the LSI, and defects of LSI derived from bus signal lines increases.

On the other hand, along with the progress in process technology, the processing capacity of LSI per unit area is enhanced. However, due to mechanical and technical limits, it is difficult to increase the number of pins, which can be used by the LSI for input/output from/to the outside, per unit area. Accordingly, when desired to build up a system by connecting a plurality of LSIs, it is demanded to utilize the limited number of external input and output pins as effectively as possible.

A method for maintaining the bus function regardless of the presence of a defect in the bus signal line is known. For example, JP-A H5-73343 (KOKAI) discloses a technique utilizing preliminarily-disposed spare signal lines. In the method disclosed in JP-A H5-73343 (KOKAI), parity check is also performed. Specifically, data is transmitted and received together with parity, and error is detected by a parity checker. When an error is detected, each bit of a data bus is sequentially replaced with a spare line. At this time, the parity check is performed to identify a defective signal line in the data bus, and the defective signal line is replaced with a spare line.

JP-A H6-250968 (KOKAI) discloses a method for maintaining data transmission using two types of independent buses. According to this method, when a trouble occurs in one bus, the other bus is employed instead through time-division multiplex. In other proposed method, data is transmitted together with Error-Correcting Code (ECC), and an error is corrected at a reception side based on the ECC.

However, when a spare signal line is prepared as in JP-A H5-73343 (KOKAI), it can be an overhead relative to the bus mounting area. Further, in inter-LSI connection, the redundant wiring occupies some external input and output pins. As a result, the number of pins usable for other functions is decreased. Further, the number of avoidable defects is restricted by the number of prepared spare signal lines.

In the method utilizing time-division multiplex, though the troubled bus can be bypassed, if a defect occurs in a common signal line, which cannot be multiplexed in time division, the defective portion cannot be bypassed. Further, the method utilizing time-division multiplex is applicable only in a system having two independent and equivalent buses, and cannot be applied in other systems.

In the method utilizing the transmission/reception of ECC information through the bus, the ECC information is transmitted and received regardless of the presence or absence of signal line defect. As a result, the bus is used for the data transmission for a longer time. In other words, the data transmission capacity of the bus may suffer from an overhead. Further, depending on the number of bits of the ECC, there is a limit in the number of bits of correctable errors, and defects exceeding the limit cannot be corrected.

### SUMMARY OF THE INVENTION

According to one aspect of the present invention, a transfer control device arranged between a bus and a bus interface, includes a bus connecting unit that is connected to plural signal lines of the bus, an interface connecting unit that is connected to plural signal lines of the bus interface, and a connection control unit that connects, when a defective signal line exists in the plural signal lines of the bus, a signal line corresponding to the defective signal line out of the plural signal lines of the bus interface and a signal line other than the defective signal line out of the plural signal lines of the bus.

Further, according to another aspect of the present invention, a large-scale integration (LSI) having a bus interface connected to a bus, and a transfer control device connected between the bus and the bus interface, wherein the transfer control device includes, a bus connecting unit that is connected to plural signal lines of the bus, an interface connecting unit that is connected to plural signal lines of the bus interface, and a connection control unit that connects, when a defective signal line exists in the plural signal lines of the bus, a signal line corresponding to the defective signal line out of the plural signal lines of the bus interface and a signal line other than the defective signal line out of the plural signal lines of the bus.

Still further, according to still another aspect of the present invention, a package having plural LSIs laminated in a vertical direction of the LSIs and connected through a bus, wherein each of the plural LSIs has a bus interface connected to the bus, and a transfer control device connected between the bus and the bus interface, and the transfer control device includes a bus connecting unit that is connected to plural signal lines of the bus, an interface connecting unit that is connected to plural signal lines of the bus interface, and a connection control unit that connects, when a defective signal line exists in the plural signal lines of the bus, a signal line corresponding to the defective signal line out of the plural signal lines of the bus interface and a signal line other than the defective signal line out of the plural signal lines of the bus.

### BRIEF DESCRIPTION OF THE DRAWINGS

FIG. 1 is a structural diagram of an LSI 1;

FIG. 2 is a table of signals transferred in signal lines;

FIG. 3 is a timing chart of signals transmitted when there is no defect in signal lines of a bus 50;

FIG. 4 is a block diagram of an overall structure of a transmission control device 10;

FIG. 5 is a table showing relations of data signal lines and D groups;

FIG. 6 is a block diagram of specific functions of a command management unit 150;

FIG. 7 is a block diagram of specific functions of a transfer management unit 170;

FIG. 8 is a flowchart of a detection process of a defective signal line;

FIG. 9 is a table showing relations of physical signal lines and logic signal lines;

FIG. 10 is a flowchart of a reception process of a signal transmitted from a transmission module 30 by the transmission control device 10;

FIG. 11 is a flowchart of a transmission process of data to the bus 50;

FIG. 12 is a flowchart of a transmission process of data to the bus 50;

FIG. 13 is a timing chart of transmission of data having a burst length of 32 bits;

FIG. 14 is a timing chart of transmission signals transmitted when a defect is found in a signal line(s) of the bus 50;

FIG. 15 is a diagram showing an overall structure of a reception control device 20;

FIG. 16 is a block diagram of specific functions of a command management unit 250;

FIG. 17 is a block diagram of specific functions of a transfer management unit 270;

FIG. 18 is a flowchart of a data reception process from the bus 50;

FIG. 19 is a flowchart of a data transmission process to a reception module 40;

FIG. 20 is a flowchart of a data transmission process to the reception module 40;

FIG. 21 is a timing chart of transmission and reception of data having a burst length of 32 bits;

FIG. 22 is a block diagram of a bus system 2 in a second embodiment;

FIG. 23 is a block diagram of a package 5 in a third embodiment;

FIG. 24 is a block diagram of an LSI 9 in a fourth embodiment; and

FIG. 25 is a block diagram of an LSI 54 in a fifth embodiment.

### DETAILED DESCRIPTION OF THE INVENTION

Embodiments of a transfer control device, an LSI, and an LSI package of the invention are specifically described below with reference to the accompanying drawings. The invention is not limited to these embodiments alone.

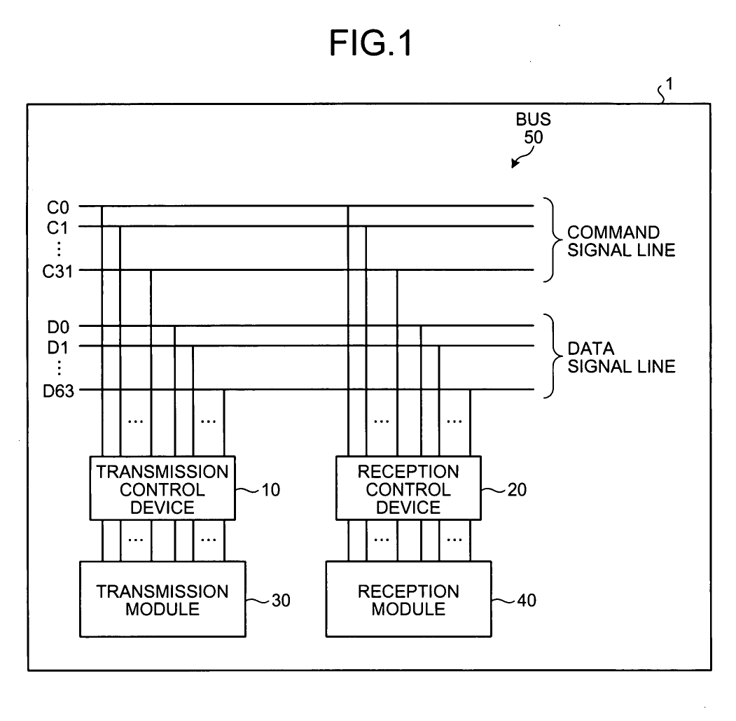

As shown in FIG. 1, an LSI 1 includes a transmission control device 10, a reception control device 20, a transmission module 30, a reception module 40, and a bus 50.

The transmission module 30 and the reception module 40 as bus interface are connected to the bus 50 by way of the transmission control device 10 and the reception control device 20, respectively. The bus 50 has a total of 96 signal lines, consisting of 32 command signal lines C0 to C31, and 64 data signal lines D0 to D63.

Command signal lines are signal lines for exchanging information necessary for data transmission between the transmission module 30 and the reception module 40. Data signal lines are signal lines used for transferring the data to be transmitted. The bus 50 therefore has a capacity of transferring data in the information quantity equal to the number of data signal lines per cycle. In the embodiment, the bus 50 has a capacity of transferring data of 64 bits.

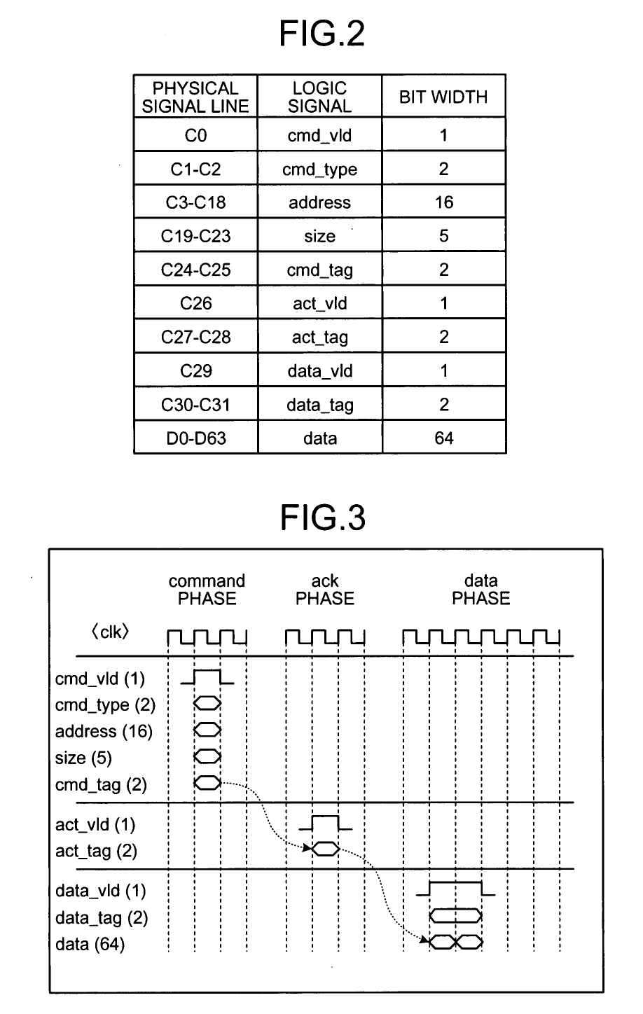

FIG. 2 shows signals flowing in the signal lines while all signal lines of the bus 50 are working normally. In FIG. 2, the signal lines, logic signals, and bit width are shown while associated with each other. Logic signals are signals flowing in the signal lines. For example, by a signal flowing in C1 and a signal flowing in C2, a logic signal cmd_type (command type) is expressed. Other logic signals are cmd_vld, address, size, cmd_tag, ack_vld, ack_tag, data_vld, and data_tag, for example.

The signal lines C0 to C25 are for commands indicating information about transfer data, such as type, address, and size of the transfer data to be transferred. These commands are sent out from the transmission module 30. The signal lines C26 to C28 are for replying to the commands. These replies are sent out from the reception module 40. The signal lines C29 to C31 are for commands transmitted in data transmission. These commands are transmitted from the transmission module 30. The signal lines D0 to D63 are for the transfer data. The transfer data is transmitted from the transmission module 30.

In the bus 50, burst transfer is performed. Burst transfer is a method of sequentially transferring data larger than the size that can be transferred in one cycle by dividing the data into plural cycles. For example, assume that data of 128 bits is to be transmitted via the bus 50 of 64 bits of the embodiment. In this case, the data of 128 bits is divided into two portions. In one cycle, hence, data of 64 bits is transferred. Transfer is repeated one more cycle. As a result, data of 64 bits×2 cycles=128 bits can be transferred.

As shown in FIG. 3, data transfer through the bus 50 consists of three phases, i.e., a command phase, an ack phase, and a data phase. In the command phase, the transmission module 30 sets 1 in the cmd_vld signal. As a result, timing of command transmission is notified to the reception module 40. At the same time, the type of command is sent out as the cmd_type signal. Further, the address in which data is desired to be written in is sent out as the address signal; the size of data (data length) desired to write in is sent out as the size signal; and a tag ID for identifying the data is sent out as the cmd_tag signal.

Next, in the ack phase, the reception module 40 notifies the transmission module 30 that the reception module 40 is ready to accept the command notified from the transmission module 30. Specifically, the same value as the tag ID notified in the command phase is transmitted as the ack_tag signal, and simultaneously the ack_vld signal is set to 1. By receiving these signals, the transmission module 30 can recognize that the data identified by the tag ID can be transferred.

Finally, in the data phase, the transmission module 30 transmits the data identified by the tag ID to the reception module 40. Specifically, 1 is set continuously in the data_vld signal during the cycle corresponding to the data length of the data desired to be transmitted. While 1 is set in the data_vld signal, the same value as the tag ID notified in the command phase is set in the data_tag signal, and the data having the data signal divided in bit number units (every 64 bits) is transmitted in every cycle sequentially from the beginning. Thus, data transfer is completed.

For example, as shown in FIG. 3, when transmitting data signal of 128 bits, 1 is set in the data_vld signal for two cycles, and data of 64 bits each is transmitted in two cycles.

These three phases are required to be executed in this order. However, there is no limit in the number of cycles in these three phases. In the embodiment, the data transfer is performed according to the bus protocol as described above. However, the bus protocol is not limited thereto.

The transmission control device 10 processes so as to send out the command and the data from the transmission module 30 to a usable signal line if a defect is found in a specific signal line of the bus 50, that is, if the specific signal line cannot be used. When a signal line of the bus 50 is not usable, the reception control device 20 processes to transmit the command and the data received from other signal line to a suitable signal line of the reception module 40.

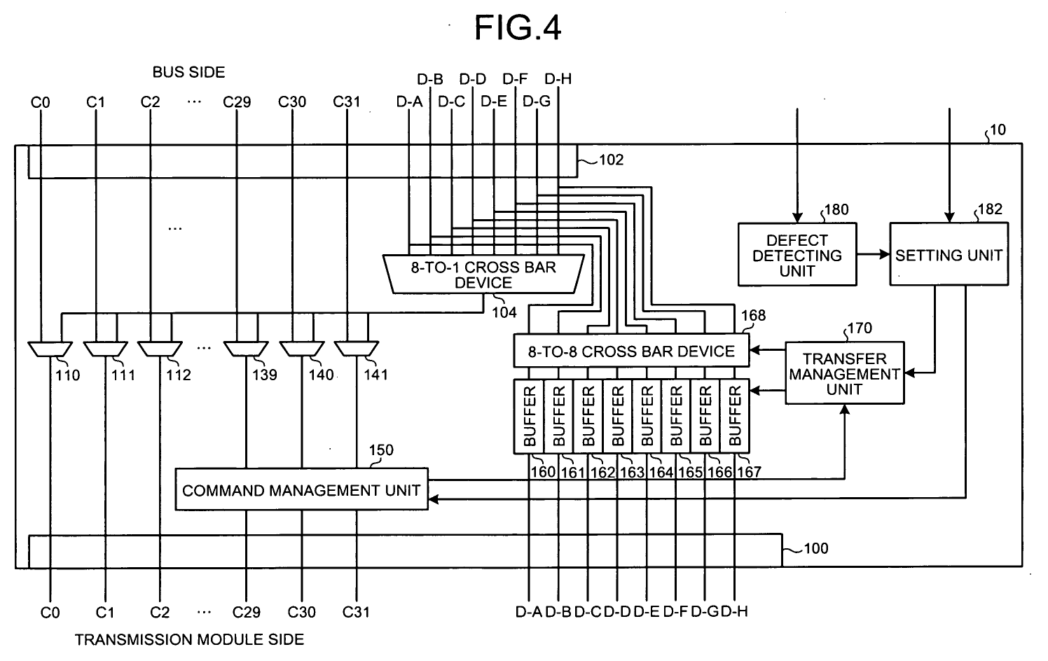

As shown in FIG. 4, the transmission control device 10 includes a transmission module side connection unit 100, a bus side connection unit 102, an 8-to-1 cross bar device 104, 9-to-1 cross bar devices 110 to 141, a command management unit 150, buffers 160 to 167, an 8-to-8 cross bar device 168, a transfer management unit 170, a defect detecting unit 180, and a setting unit 182.

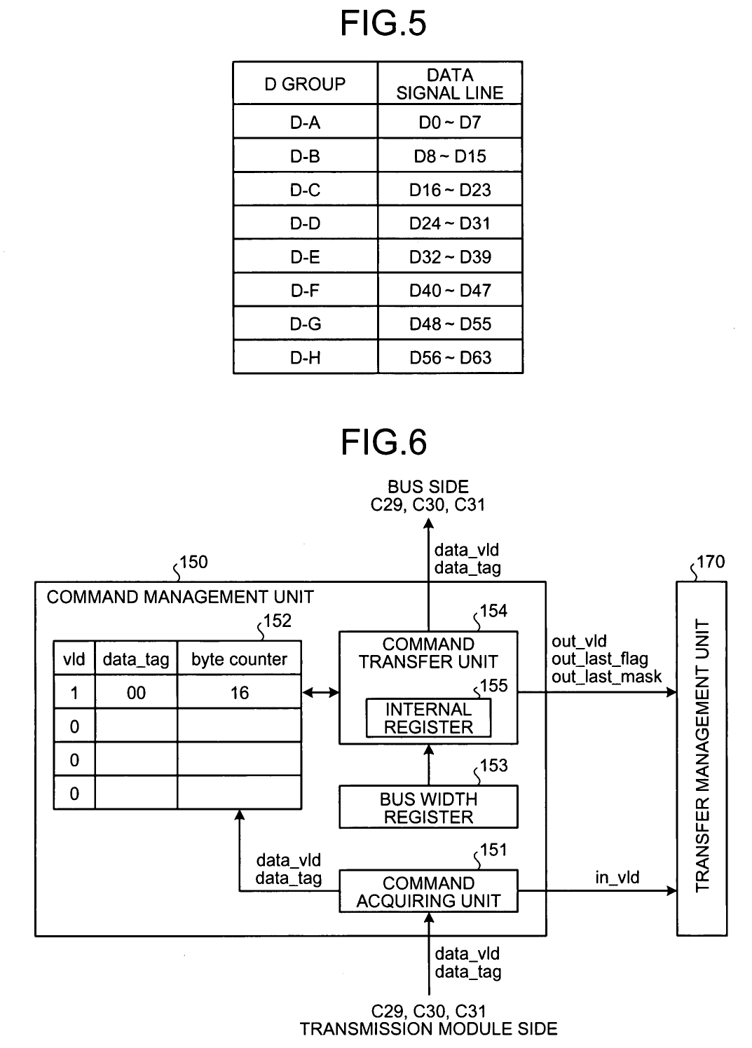

The transmission module side connection unit 100 is connected to the transmission module 30. The bus side connection unit 102 is connected to the bus 50. In FIG. 4, D-A to D-H are D groups of 8 bits each out of D0 to D63. The D group is a set of 8 data signal lines, and as shown in FIG. 5, D-A to D-H are D groups including respectively D0 to D7, D8 to D15, D16 to D23, D24 to D31, D32 to D39, D40 to D47, D48 to D55, and D56 to D63.

The 8-to-1 cross bar device 104 selects one D group out of eight D groups in the bus side connection unit 102. An arbitrary bit of the selected D group is connected to 9-to-1 cross bar devices 110 to 141.

To the 9-to-1 cross bar device 110, eight data signal lines of the D group selected by the 8-to-1 cross bar device 104, and one command signal line of the bus side connection unit 102 corresponding to C0 are connected. The 9-to-1 cross bar device 110 selects one out of the total of nine lines. The selected one signal line is connected to a command signal line of the transmission module side connection unit 100 corresponding to C0.

The 9-to-1 cross bar devices 110 to 141 similarly connect one command line of the bus side connection unit 102 and one signal line of eight data signal lines to one command signal line of the transmission module side connection unit 100. The 9-to-1 cross bar devices 110 to 141 are cross bar devices in the width of one bit.

In this configuration, by controlling the connection of the 9-to-1 cross bar devices 110 to 141 and the 8-to-1 cross bar device 104, the command signal line of the transmission module side connection unit 100 can be connected to any one D group out of data signal lines D-A to D-H through the bus side connection unit 102. Therefore, if a defect occurs in the command signal line of the bus 50, a specified D group is selected, and an arbitrary bit of the selected D group is connected to the defective command signal line, so that all commands can be transferred to the reception module 40.

Further, the command management unit 150 is provided between the C29 to C31 and the 9-to-1 cross bar devices 139 to 141. The command management unit 150 monitors signals on C29 to C31, that is, the data_vld signal and the data_tag signal. The command management unit 150 corrects these signals properly. Further, the command management unit 150 controls the timing of data transfer by the bus side connection unit 102 based on the data_vld signal and the data_tag signal.

Eight D groups of the transmission module side connection unit 100 are connected to the 8-to-8 cross bar device 168 respectively through buffers 160 to 167. To the opposite side of the 8-to-8 cross bar device 168, eight D groups of the bus side connection unit 102 are connected.

If a defect occurs in the data signal line of the bus 50, the defective data signal line cannot be used. Accordingly, a D group of the transmission side connection unit 100 is connected to a normal D group without defect by the 8-to-8 cross bar device 168.

Further, if the data signal line is utilized to compensate for defect in command signal line as mentioned above, a shortage occurs in the data signal lines for data transfer. In this case, the insufficient data signal line of the transmission module side connection unit 100 is connected to a normal data signal line by the 8-to-8 cross bar device 168. As a result, all the data can be transmitted to the reception module 40.

Decrease in the number of data signal lines is compensated for by increasing the number of times of data transfer, and all data can be transferred. Specifically, the data of 64-bit width transmitted from the transmission module 30 is converted, depending on the data length, into data in width of 8×n (n=1 to 7) bits, and sent out to the bus 50. Herein, n is the number of data signal lines (D-A to D-H) in the 8-bit unit that can be used in data transmission.

The transfer management unit 170 manages the 8-to-8 cross bar device 168. That is, the signal lines of the bus side connection unit 102 as connection destinations of the buffers 160 to 167 are determined. Further, according to the instruction of the command management unit 150, the timing of transmission of data to the bus side connection unit 102 from the buffers 160 to 167 is controlled.

For example, if the usable data signal lines of the bus 50 side are less than the width of 64 bits (n<7), the 64-bit data transmitted from the transmission module 30 cannot be transmitted to the bus 50 in one cycle. Accordingly, the data not transmitted in one cycle is temporarily held in the buffers 160 to 167, and transmitted to the bus 50 side in plural cycles.

The defect detecting unit 180 detects if a defect is present or not in the signal line of the bus 50. The setting unit 182 sets a specified value in the command management unit 150 and the transfer management unit 170 based on the detection result of the defect detecting unit 180. The setting unit 182 further sets the 9-to-1 cross bar devices 110 to 141 and the 8-to-1 cross bar device 104. Detail is described later.

In the transmission control device 10 of the embodiment, 64 data lines can be replaced in 8-bit units, but this is for the sake of simplicity of structure, and the data lines can be replaced in 1-bit units. That is, a buffer may be provided in every bit, and the 8-to-1 cross bar device 104 may be replaced by a 64-to-1 cross bar device.

As shown in FIG. 6, the command management unit 150 includes a command acquiring unit 151, a byte counter table 152, a bus width register 153, and a command transfer unit 154. The command transfer unit 154 has an internal register 155.

The command acquiring unit 151 monitors the data_vld signal and the data_tag signal output from the transmission module 30 and flowing in C29 to C31. When receiving a new command, the command acquiring unit 151 registers a new entry of data transmission in the byte counter table 152. Further, the command acquiring unit 151 transmits an in_vld signal to the transfer management unit 170 while registering the new entry.

The byte counter table 152 has a vld field, a data_tag field, and a byte counter field. The value of the vld field changes from 0 to 1 when the object entry is being processed. In the data_tag field, a tag ID of data is stored. In the byte counter field, the data size is stored.

In the bus width register 153, the bus width (transfer width) of burst transfer is held. The bus width is preset according to the number of defective signal lines in the bus 50. The bus width setting method is described later.

The command transfer unit 154 monitors the data transferred from the transmission module 30 to the bus 50, and increments the value of the internal register 155 in every cycle, each by the bus width stored in the bus width register 153. Referring to the byte counter table 152 and the internal register 155, the command transfer unit 154 instructs the transfer management unit 170 to transfer the data.

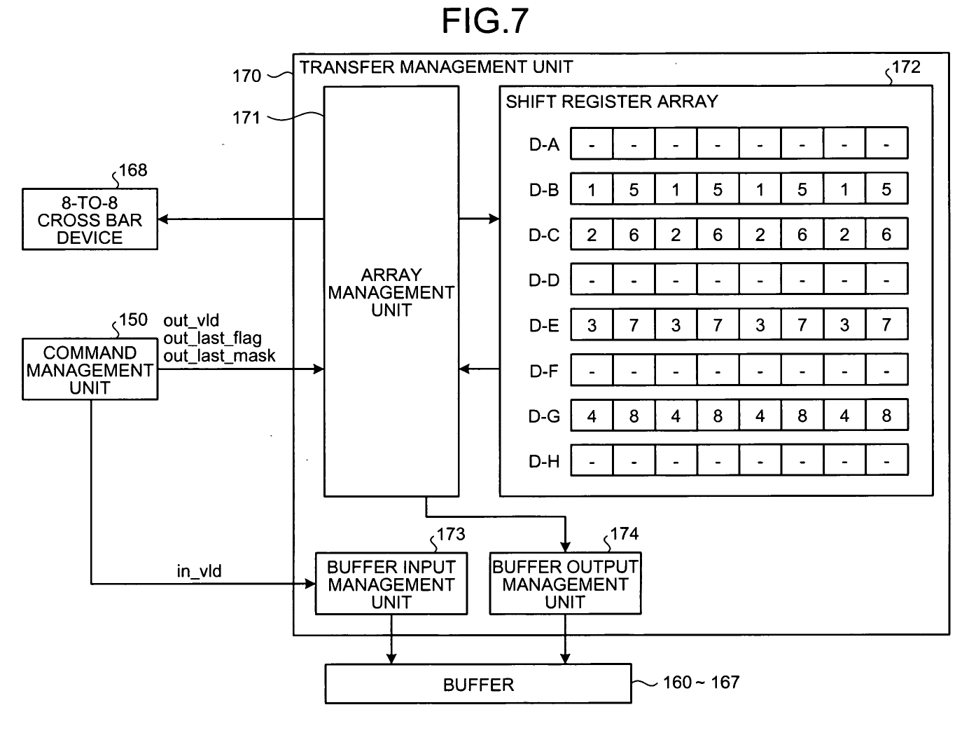

As shown in FIG. 7, the transfer management unit 170 includes an array management unit 171, a shift register array 172, a buffer input management unit 173, and a buffer output management unit 174. The array management unit 171, on receiving the out_vld signal from the command management unit 150, refers to the shift register array 172, and instructs the 8-to-8 cross bar device 168 to connect a specified buffer and a specified D group in the bus side connection unit 102. The shift register array 172 has eight shift registers corresponding to D-A to D-H. A buffer number is stored preliminarily in each shift register. Setting method of the buffer number stored in, the shift register array 172 is described later.

In the example shown in FIG. 7, buffer numbers 1 to 4 are stored at beginning entries of shift registers D-B, D-C, D-E, and D-G, respectively. It means that the data signal lines D-B, D-C, D-E, and D-G of the bus 50 side are connected to the buffers 160 to 163 of buffer numbers 1 to 4, respectively. The buffers 160 to 167 are in the order of buffer numbers 1 to 8. The 8-to-8 cross bar device 168 connects the buffers and the data lines according to this instruction. In the shift registers, the “−” mark indicates that it is not connected to any buffer.

The shift register array 172 is read by the array management unit 171 sequentially from the beginning entry (the leftmost entry in the drawing). The shift register array 172 is a circular shift register. That is, when the beginning entry is read out, this entry is moved to the tail (the rightmost entry in the drawing), and all remaining entries are shifted by one to the left. In the embodiment, since eight entries are provided, the sequence returns to the initial state after eight cycles.

For example, in the state shown in FIG. 7, first the beginning entry is read out, and the array management unit 171 transmits the array information indicating connection of D-B with buffer 1, D-C with buffer 2, D-E with buffer 3, and D-G with buffer 4, to the 8-to-8 cross bar device 168. In the next cycle, as the sequence has been shifted to the left by one, the second entry from the left in FIG. 7 is the beginning entry. Therefore, the array management unit 171 transmits the array information indicating connection of D-B with buffer 5, D-C with buffer 6, D-E with buffer 7, and D-G with buffer 8, to the 8-to-8 cross bar device 168.

The buffer input management unit 173 stores data in the buffers 160 to 167 according to the instruction of the in_vld signal output from the command management unit 150. The buffer output management unit 174 outputs the data of the buffers 160 to 167 to the 8-to-8 cross bar device 168 according to the instruction of the array management unit 171.

Data transfer process by the transmission control device 10, according to which the wiring defect in the bus 50 is bypassed, roughly consists of “test and configuration phase before system shipping” and “dynamic signal line changing phase at the time of operation of the device.”

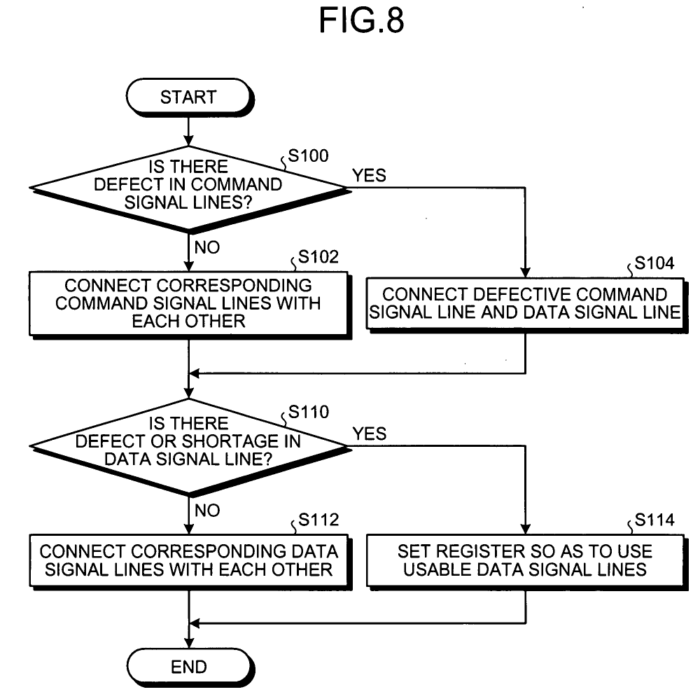

In “test and configuration phase before system shipping”, a defective signal line is detected and processed. By this process, the bus width of the command transfer unit 154 and the value of the shift register array 172 are set. Specifically, as shown in FIG. 8, in a defective signal line detection process, the defect detecting unit 180 first detects a defect in the command signal line of the bus 50. For example, the defect detecting unit 180 detects by Built-In Self Test (BIST).

When defect is not detected in the command signal line (No at step S100), the setting unit 182 sets the 9-to-1 cross bar devices 110 to 141 so as to connect one command signal line out of one command signal line and eight data signal lines of the bus side connection unit 102 connected to the 9-to-1 cross bar devices 110 to 141, to a corresponding command line of the transmission module side connection unit 100 (step S102). As a result, C0 to C31 of the transmission module side connection unit 100 are respectively connected to C0 to C31 of the bus side connection unit 102.

On the other hand, when defect is detected in the command signal line (Yes at step S100), the setting unit 182 sets the 9-to-1 cross bar devices 110 to 141 so as to connect specified one data signal line out of nine signal lines of the 9-to-1 cross bar devices 110 to 141 connected to the defective command line, to a corresponding command signal line of the transmission module side connection unit 100 (step S104). As a result, the command signal line of the transmission module side connection unit 100 corresponding to the defective signal line and the data signal lines connected to the 9-to-1 cross bar devices 110 to 141 are connected.

Further, when the data signal lines have neither defect nor shortage (No at step S110), D-A to D-H of the transmission module side connection unit 100 are respectively connected to D-A to D-H of the bus side connection unit 102 (step S112). In the bus width register 153, “8” is stored. That the data signal lines have no shortage means that defect is not found in the command signal lines of the bus 50, and the corresponding command signal lines of the reception module 40 are not connected to arbitrary data signal lines of the bus 50.

On the other hand, when the data signal lines have defect or the data signal lines have shortage (Yes at step S110), the setting unit 182 sets the values of the bus width register 153 of the command management unit 150 and the shift register array 172 of the transfer management unit 170 so as to use the usable data lines (step S114). Specifically, in the bus width register 153, the number of usable D groups is stored. In the shift register array 172, the buffer numbers connected to the usable data signal lines are stored for each cycle.

Detecting process of defective signal lines performed when a defect occurs in C1, C26, D0, D28, D39, and D51 is specifically described. In this case (Yes at step S100), at step S104, the 8-to-1 cross bar device 104 is set so that a D group having non-defective signal lines of the number sufficient for covering the number of defective command signal lines may be selected. Further, the 9-to-1 cross bar devices 110 to 141 are set so as to sequentially replace the defective signal lines with the non-defective signal lines in the D group.

Specifically, in the 8-to-1 cross bar device 104, an arbitrary D group is selected from eight D groups. In the embodiment, D-E (D32 to D39) is selected as a D group for compensating for the command signal lines.

When the D group is used to compensate for the defective signal line, the number of cycles of data transfer must be increased for this portion. Preferably, D groups are selected so as to minimize the number of D groups to be used to compensate for defective signal lines. Specifically, D groups including defective signal lines are selected.

Further, the 9-to-1 cross bar device 111 connected to C1 at the reception module 40 side is set to be connected to D32 at the bus 50 side, instead of C1 at the bus 50 side. The 9-to-1 cross bar device 136 connected to C26 at the module side is set to be connected to D33 at the bus 50 side. The other command signal lines of the bus 50 side, i.e., C0, C2 to C25, and C27 to C31 are connected to the corresponding command signal lines of the transmission module 30 as before. In the 9-to-1 cross bar devices 110, 112 to 135, and 137 to 141 corresponding to these command signals, these command signal lines are connected to each other.

Further, defects are also present in the data signal lines, and to transmit and receive data by using only defect-free D groups out of D groups at the bus 50 side, the values of the bus width register 153 of the command management unit 150 and the shift register array 172 of the transfer management unit 170 are set so as to connect the D groups at the bus 50 side and the D groups of the transmission module 30 side (step S114).

Since defects are present in D0, D28, D39, and D51, the D groups including these signal lines, that is, D-A (D0 to D7), D-D (D24 to D31), D-E (D32 to D39), and D-G (D40 to D47), cannot be used for data transfer. Accordingly, data is transferred via 32-bit data signal lines in other D groups, i.e., D-B (D8 to D15), D-C (D16 to D23), D-F (D40 to D47), and D-H (D56 to D63).

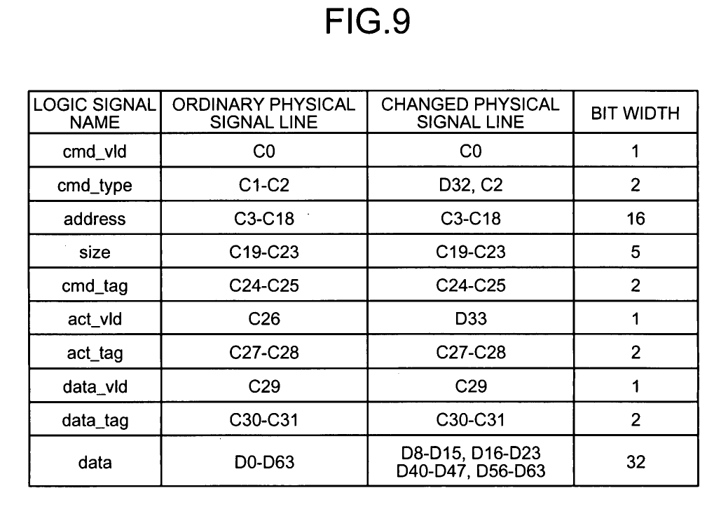

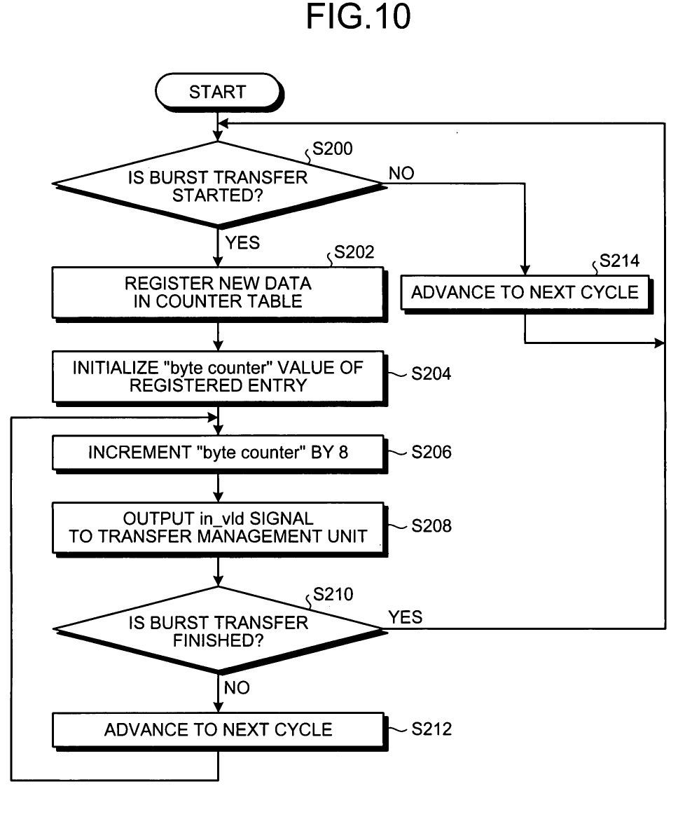

FIG. 9 shows the correspondence between logic signals and physical signal lines in the presence of defects in C1, C26, D0, D28, D39, and D51. In FIG. 9, “Ordinary Physical Signal Line” means physical signal lines corresponding to logic signals when defect is present in none of the signal lines. Further, “Changed Physical Signal Line” means physical signal lines corresponding to logic signals when defects are present in C1, C26, D0, D28, D39, and D51.

When all signal lines are free from defects, the bit width usable for data transfer is 64, but when defects are present in C1, C26, D0, D28, D39, and D51, the bit width usable for data transfer is 32 bits. Accordingly, the 64-bit data that can be transferred originally in one cycle is transferred in two cycles, 32 bits each.

That is, at step S114, the setting unit 182 sets “4” in the bus width register 153 of the command management unit 150 as the number of usable D groups. Further, the setting unit 182 sets “−” in the shift register of the D groups not usable in data transfer in the shift register array 172 of the transfer management unit 170. At each beginning of D-B, D-C, D-E, and D-G usable in data transfer, buffer numbers 1 to 4 are set, and buffer numbers 5 to 8 are set in next entries of D-B, D-C, D-E, and D-G. Similarly, buffer numbers are registered in eight entries of each shift register.

By thus setting the bus width register 153 of the command management unit 150 and the shift register array 172 of the transfer management unit 170, data transfer is possible using other signal lines than defective signal lines.

When all data signal lines of 64 bits of D0 to D63 can be used in data transfer (No at step S100), the setting unit 182 sets the 9-to-1 cross bar devices 110 to 141 at step S102 so that the command signal lines C0 to C31 of the bus 50 and the command signal lines C0 to C31 of the transmission module 30 can be connected.

At step S112, register values are set so that the data signal lines of D0 to D63 of the bus 50 are connected to data signal lines of D0 to D64 at the reception module 40 side. Specifically, the setting unit 182 sets “8” in the bus width register 153 of the command management unit 150. Further, the setting unit 182 sets “1” in all entries of D-A of the shift register array 172 of the transfer management unit 170, and sets “2” in all entries of D-B. Similarly, “3” to “8” are set in entries of D-C to D-H, respectively.

The detection process of defective signal lines explained above is executed before the shipping of products. Therefore, at the time of shipping, values corresponding to defect signals are preset in the bus width register 153 of the command management unit 150 and the shift register array 172 of the transfer management unit 170.

In other example, the detection process of defective signal lines may be executed periodically. In this case, every time the detection process is executed, the values of the bus width register 153 and the shift register array 172 are updated.

In “dynamic signal line changing phase at the time of operation of the device,” a reception process of the signal transmitted from the transmission module 30 is executed. In the reception process, the command acquiring unit 151 monitors the data_vld signal and the data_tag signal of the command signal lines of C29, C30, and C31 of the transmission module 30 side as shown in FIG. 10. Specifically, the command acquiring unit 151 determines that a new burst transfer has been started when the data_vld signal transmitted from the transmission module 30 is changed from 0 to 1.

Further, the command acquiring unit 151 determines that a new burst transfer has been started, even if the data_vld signal remains at 1, if the two-bit value of the data_tag signal indicated by C30 and C31 is changed over. When burst transfers of plural pieces of data are executed in parallel, and if a burst transfer of one piece of data is started during a burst transfer of another piece of data, the data_vld signal is changed from 0 to 1 upon the start of the burst transfer of the another piece of data. Accordingly, the start of the burst transfer of the one piece of data is judged based on the changeover of the data_tag signal.

When the burst transfer is started (Yes at step S200), new data is registered in the byte counter table 152 (step S202). Specifically, data is registered in the entries whose vld field is 0, sequentially from the beginning entry (highest entry in FIG. 6) to final entry (lowest entry in FIG. 6) of the byte counter table 152. When the immediately preceding entry is the final entry, new data is registered in the beginning entry. In the tag field, the value of the data_tag signal is registered (step S204). Next, the byte counter value of the corresponding entry is initialized to 0 (step S206).

While the data_vld signal remains to be “1” and the data_tag signal keeps indicating the same value, the same data is in the process of burst transfer. Accordingly, the command acquiring unit 151 continues to increment the byte counter value of the corresponding entry by 8 every cycle during this period (step S206). Further, in this cycle, the in_vld signal is sent out to the transfer management unit 170. That is, “1” is asserted (step S208). The buffer input management unit 173 of the transfer management unit 170, on receiving the in_vld signal, stores the corresponding data in the buffers 160 to 167.

Next, when the data_vld signal is changed from 1 to 0, it is determined that burst transfer of corresponding data is finished (Yes at step S210), and the incrementing of the byte counter of this entry is stopped, and the process waits for a start of next burst transfer (step S200).

Even if the data_vld signal remains to be 1, when the value of the data_tag signal is changed, the incrementing of the byte counter of the entry is stopped. When burst transfers of plural data are executed continuously, and if a burst transfer of one piece of data is terminated before a burst transfer of another piece of data is terminated, the value of the data_vld signal is not changed from 1 to 0. In this case, however, the value of the data_tag signal is changed from a value corresponding to the one piece of data to a value corresponding to the another piece of data. As a result, it is determined that the burst transfer of the one piece of data is finished based on the change of the data_tag signal.

On the other hand, when it is determined that the burst transfer has not finished (No at step S210), the process advances to next cycle (step S212), and returns to step S206.

The burst width of the burst transfer is 64 bits. Therefore, transfer of data of, for example, 128 bits requires two cycles. In the case of transfer of data of 128 bits, 2×8=16 is set in the byte counter. Further, during the burst transfer, the processes of step S206 to step S210 are repeated, and the in_vld signal is transmitted continuously to the transfer management unit 170.

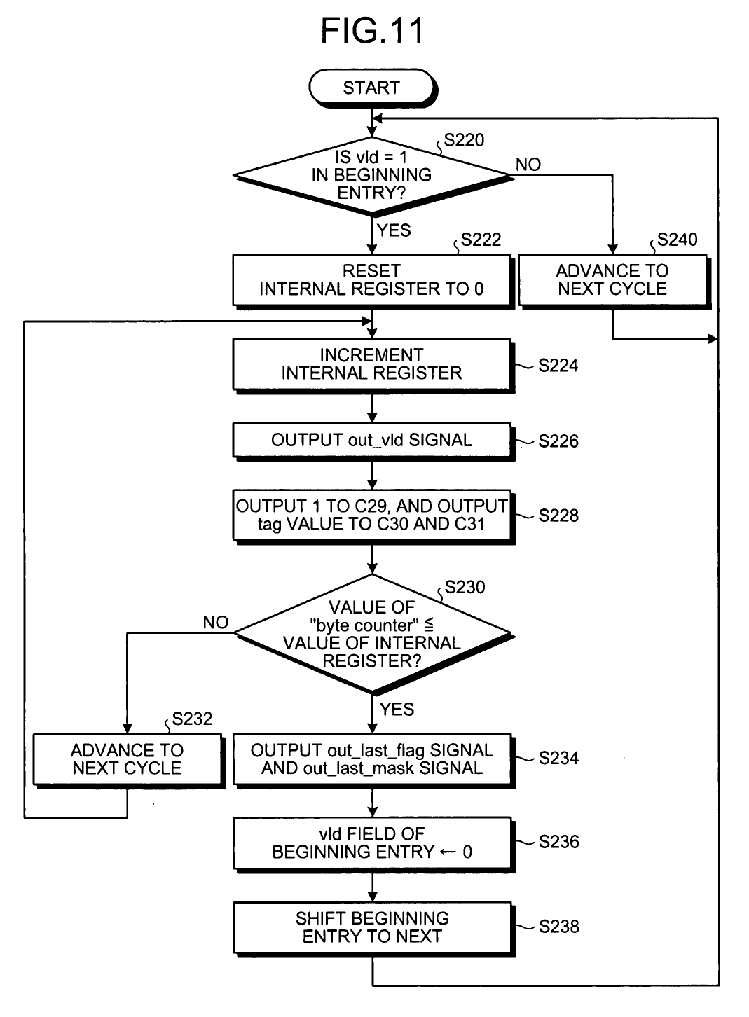

Further, in “dynamic signal line changing phase at the time of operation of the device”, the data received from the transmission module 30 is transmitted to the bus 50. In this process, the command transfer unit 154 starts sending out the data indicated by the tag ID indicated by a corresponding data_tag signal to the bus 50, when the vld field of the beginning entry in the byte counter table 152 is changed from 0 to 1 (Yes at step S220), as shown in FIG. 11.

Specifically, the value of the internal register 155 is reset to 0 (step S222). Thereafter, the value of the internal register 155 is incremented by the value stored in the bus width register 153 in every cycle (step S224). In this period, the out_vld signal is output to the transfer management unit 170. That is, “1” is asserted (step S226). Further, “1” is output to C29, and the tag ID is output to C30 and C31 (step S228). The timing of outputting “1” to C29 and outputting the tag ID to C30 and C31 is controlled so as to be simultaneous with the timing of outputting data from the 8-to-8 cross bar device 168 to the bus side connection unit 102.

The above process is continued until the value of the internal register 155 becomes equal to or higher than the value of byte counter of the byte counter table 152. While the value of the internal register 155 is less than the value of byte counter of the byte counter table 152 (No at step S230), data transfer to the bus 50 of data identified by the tag ID is not completed. Therefore, the process goes to next step (S232), and the value of the internal register 155 is incremented again by the value of the bus width register 153 (step S224), and further the process advances to step S226.

When the value of the internal register 155 becomes equal to or higher than the value of byte counter of the byte counter table 152 (Yes at step S230), since the data transfer to the bus 50 of the data identified by the tag ID has been completed, an out_last_flag signal is output to the transfer management unit 170. That is, “1” is asserted.

At the same time, the value obtained by subtracting the value of byte counter of the byte counter table 152 from the value of the internal register 155 is output as an out_last_mask signal to the transfer management unit 170 (step S234). The out_last_mask signal indicates how many final bytes are invalid out of the value of the bus width register 153, i.e., the data width (byte value) usable in data transfer. For example, when transferring data of 32 bits to the data width of 48 bits, the final 8 bits are invalid, and “1” is output as the out_last_mask signal value for the 8 bits.

Simultaneously with this process, the vld field of the entry which is presently being processed in the byte counter table 152 is set to 0, and the incrementing is stopped (step S236). Further, the beginning entry of the byte counter table 152 is moved to next entry (step S238).

The “next entry” means the entry corresponding to the data received from the transmission module 30 next to the data transferred immediately before. If the entry of the data transferred immediately before is the final entry of the table, the next entry is the beginning entry. Subsequently, when the vld field of next entry is 1, the command transfer unit 154 performs the transfer of the data indicated by the tag ID to the bus 50 according to the same procedure as described above.

Also, in “dynamic signal line changing phase at the time of operation of the device”, the transmission management unit 170 performs a transmission process. In the transmission process, according to the instruction from the command management unit 150, data is output from a specified buffer out of the buffers 160 to 167 every cycle.

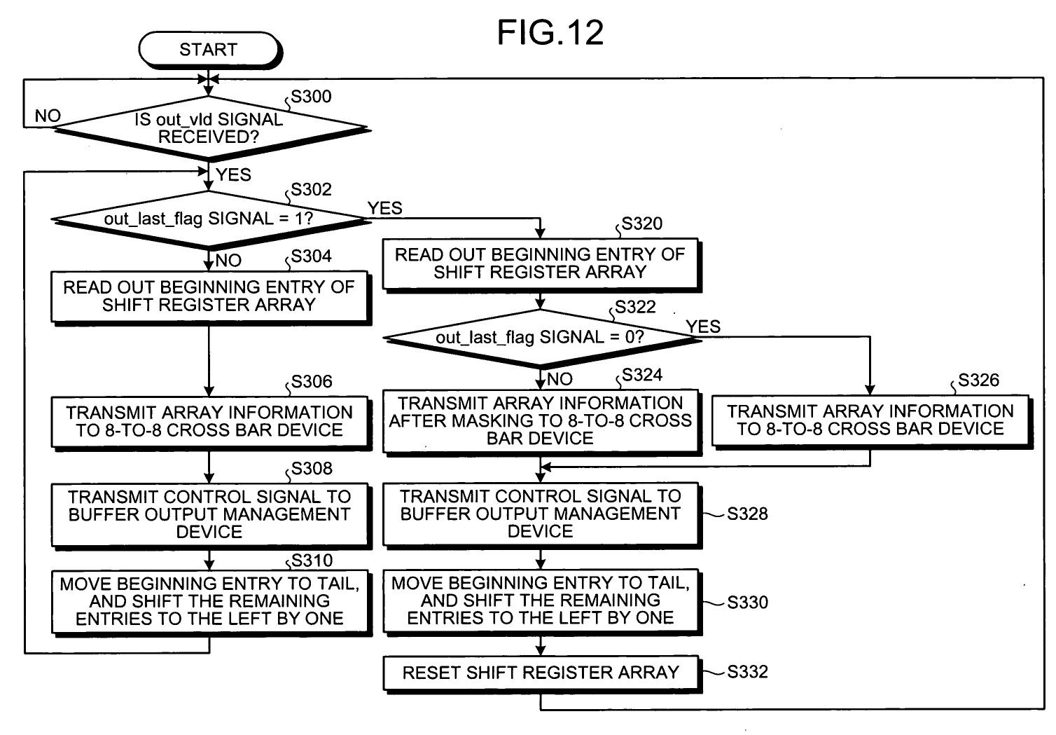

Specifically, when the array management unit 171 receives the out_vld signal from the command management unit 150 (Yes at step S300), the transmission process is started as shown in FIG. 12. Next, it is checked if the out_last_flag signal is 0 or 1. When the data transfer is completed, the out_last_flag signal is changed from 0 to 1.

When the out_last_flag signal is 0, that is, when the data transfer is in process (No at S302), eight beginning entries of the shift register array 172 are read out (step S304). Array information indicating values of the read-out beginning entries is transmitted to the 8-to-8 cross bar device 168 (step S306). To control the reading of buffers 160 to 167 indicated by the array information, a control signal is transmitted to the buffer output management unit 174 (step S308).

When receiving the array information, the 8-to-8 cross bar device 168 connects the buffers 160 to 167 to the D groups of the bus 50 side according to the array information. Next, the beginning entry is moved to the tail, and the remaining entries are shifted by one to the left (to the beginning side) (step S310). The process returns to step S302.

In this manner, if there is defect in the data signal line or the command signal line of the bus 50, data can be transferred with the use of only the usable signal lines for data transfer out of the data signal lines of the bus 50.

On the other hand, when the out_last_flag signal is 1, that is, when the data transfer is completed (Yes at S302), eight beginning entries of the shift register array 172 are read out (step S320). Next, the value of the out_last_mask signal is confirmed.

When the out_last_mask signal is other than 0 (No at step S322), the value of the beginning entry is masked according to the value of the out_last_mask signal. That is, the buffer number is changed to “−” and is invalidated. Specifically, it is checked if the value of the beginning entry is “−” or not sequentially from D-H to D-A. If the value is other than “−”, it is changed to “−”. This process of changing other values to “−” is repeated by the number of times indicated by the value of the out_last_mask signal. The array information indicating the value of the beginning entry after masking is transmitted to the 8-to-8 cross bar device 168 (step S324).

On the other hand, when the out_last_mask signal is 0 (Yes at step S322), the array information indicating the beginning entry is transmitted to the 8-to-8 cross bar device 168 (step S326).

To control the reading of the buffers 160 to 167 indicated by the array information, a control signal is transmitted to the buffer output management unit 174 (step S328). Next, the array management unit 171 moves the beginning entry to the tail, and shifts the remaining entries by one to the left (step S330).

Further, the array management unit 171 resets the shift register array 172 (step S332). Specifically, the array management unit 171 has a 3-bit saturation counter not shown, and counts the number of times of the out_vld signal by the 3-bit saturation counter, counting 0 as initial value. When the out_last_flag signal is received, the shift register array 172 is shifted by one to the left until the count value becomes 0 again. The beginning entry is moved to the tail. After resetting of the shift register array 172, at step S300, the process waits until receiving the out_vld signal again.

Thus, by performing the data transfer using only the usable data signal lines while monitoring the timing of the data transfer, the command and the data can be transmitted securely even if there is a defect in the bus 50.

Procedure of transfer of 128-bit data when the buffer numbers shown in FIG. 7 are set in the shift register array 172 due to defects occurring in C1, C26, D0, D28, D39, and D51 is specifically described below. In this case, when the array management unit 171 receives the out_vld signal (Yes at S300), the beginning entry of the shift register array 172 is read out (step S304). The array information defining correspondence between D-B, D-C, D-E, D-H and the buffer numbers 1 to 4 is transmitted to the 8-to-8 cross bar device 168 (step S306).

The 8-to-8 cross bar device 168 connects, based on the array information, the bus side D-B, D-C, D-E, D-H to the buffers 160 to 163 identified by the buffer numbers 1 to 4. At this time, 128-bit data is stored in the buffers 160 to 167 according to the instruction from the buffer input management unit 173. The buffer output management unit 174 transmits the data of 32 bits out of 128-bit data to the bus 50 in one cycle.

In the shift register array 172, the entries are moved to the left by one (step S310). As a result, the beginning entry is moved to the tail, and the second entry from the left in FIG. 7 becomes the beginning entry.

Back to step S302, the beginning entry of the shift register array 172 is read out (step S304). The array information defining the correspondence between D-B, D-C, D-E, D-H and the buffer numbers 5 to 8 is transmitted to the 8-to-8 cross bar device 168 (step S306).

The 8-to-8 cross bar device 168 connects, based on the array information, the bus side D-B, D-C, D-E, D-H to the buffers 160 to 163 identified by the buffer numbers 5 to 8. In the shift register array 172, the entries are moved to the left by one (step S308). As a result, the beginning entry (the second entry from the left in FIG. 7) is moved to the tail, and the third entry from the left in FIG. 7 becomes the beginning entry.

Back to step S302 again, the beginning entry of the shift register array 172 is read out (step S304). The array information defining the correspondence between D-B, D-C, D-E, D-H and the buffer numbers 1 to 4 is transmitted to the 8-to-8 cross bar device 168 (step S306), and the bus side D-B, D-C, D-E, D-H are connected to the buffers 160 to 163 identified by the buffer numbers 1 to 4, and the data stored in the buffer numbers 1 to 4 is transmitted to the bus 50. Further, the beginning entry is moved to the tail, and the remaining entries are moved to the left by one. As a result, the beginning entry at this moment (the third entry from the left in FIG. 7) is moved to the tail, and the fourth entry from the left in FIG. 7 becomes the beginning entry.

The next cycle is the final cycle, and the array management unit 171 receives the out_last_flag signal and the out_last_mask signal together with the out_vld signal. In this case, the out_last_mask signal is 0.

Moreover, the beginning entry of the shift register array 172 is read out (step S320). The array information defining the correspondence between D-B, D-C, D-E, D-H and the buffer numbers 5 to 8 is transmitted to the 8-to-8 cross bar device 168 (Yes at step S322, step S326).

The 8-to-8 cross bar device 168 connects, based on the array information, the bus side D-B, D-C, D-E, D-H to the buffers 164 to 167 identified by the buffer numbers 5 to 8. The buffer output management unit 174 transmits the data of 32 bits out of the total data to the bus 50 in one cycle. In this way, the data usually transferred in one cycle is divided into two portions, and transferred in two cycles, and all data can be transferred.

In the shift register array 172, the entries are moved to the left by one (step S330). As a result, the beginning entry is moved to the tail, and the fifth entry from the left in FIG. 7 becomes the beginning entry. By this process, transfer of the data of 128 bits is completed.

Next, the array management unit 171 resets the shift register array 172 (step S332). In this case, since the entries are shifted to the left by four, the shift register array 172 is returned to the original state by moving to the left by four.

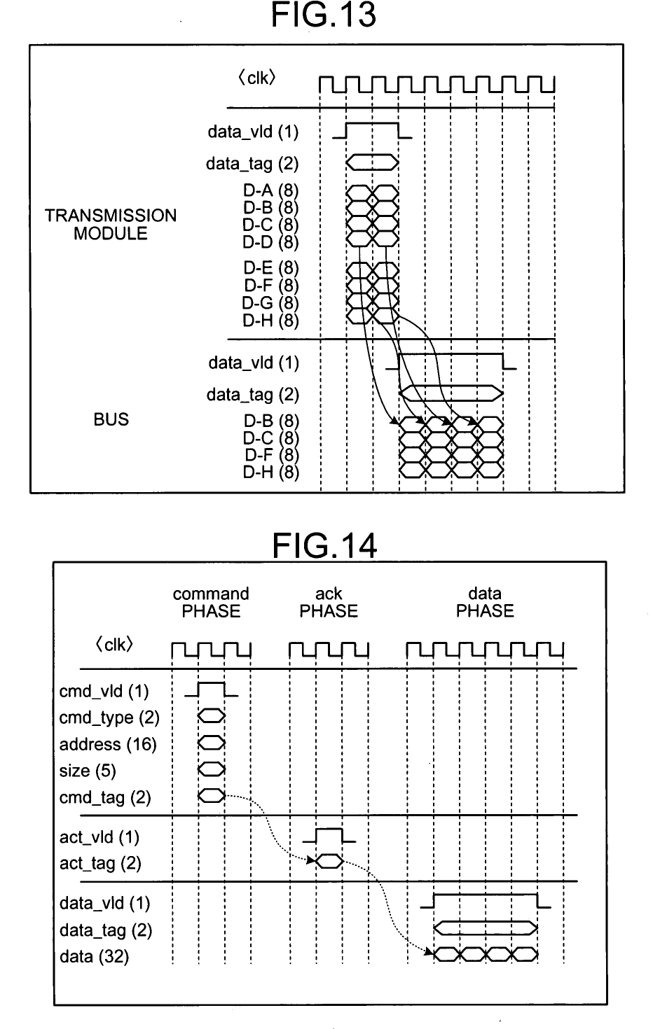

Thus, according to defects in the bus 50, based on the values set in the bus width register 152 and the shift register array 172, the command management unit 150 and the transfer management unit 170 operate. Thus, as shown in FIG. 13, the data of 64 bits×2 cycles transmitted from the transmission module 30 based on the assumption that the bus 50 does not have defective signal lines is sent out to the bus 50 as data of 32 bits×4 cycles by the transmission control device 10. Thus, by making the burst length longer, the data can be securely transmitted to the reception module 40 with the use of normal signal lines other than defective signal lines.

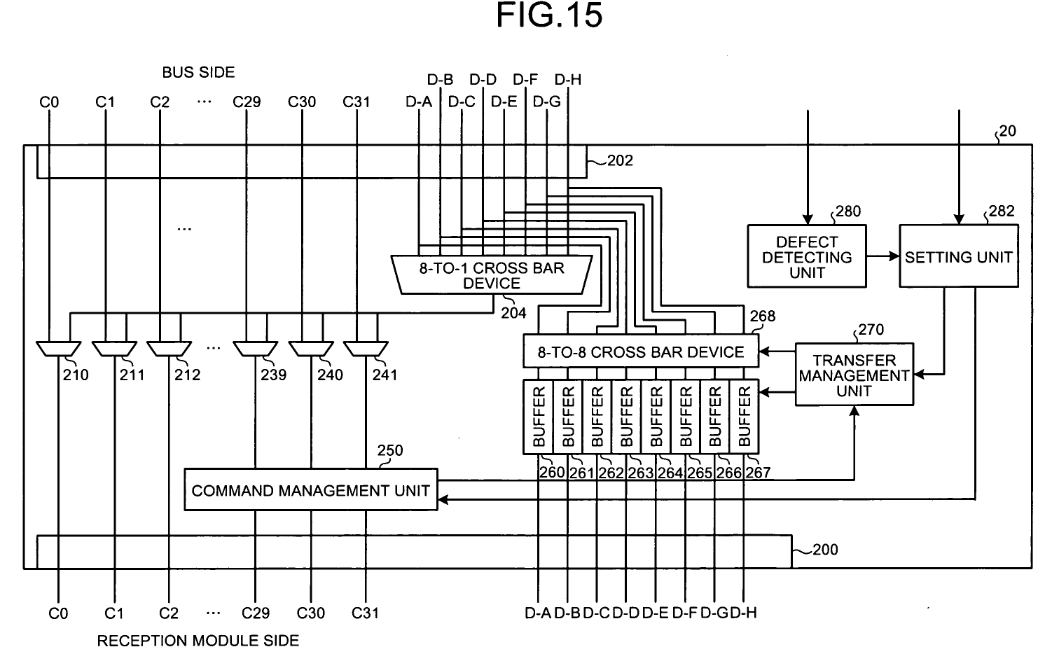

Further, as shown in FIG. 14, in the bus operation from the command phase to the data phase, the burst length is 4 cycles, two times longer than usual.

In the embodiment, moreover, the command signal line is not selected as connection destination of the defective signal line, and only the data signal line capable of burst transfer is selected. As a result, the command signal is transferred at specified timing without delay.

As shown in FIG. 15, the reception control device 20 includes a reception module side connection unit 200, a bus side connection unit 202, an 8-to-1 cross bar device 204, 9-to-1 cross bar devices 210 to 241, a command management unit 250, buffers 260 to 267, an 8-to-8 cross bar device 268, a transfer management unit 270, a defect detecting unit 280, and a register setting unit 282. Structure and operation of the reception control device 20 are nearly the same as those of the transmission control device 10. Differences are explained below.

The reception module side connection unit 200 is connected to the reception module 40. The bus side connection unit 202 is connected to the bus 50. The command management unit 250 monitors the signals output from the 9-to-1 cross bar devices 239 to 241 connected to the bus 50 side C29, C30, C31. These signals are properly corrected. Further, based on the data_vld signal and the data_tag signal, the timing of data reception by the bus side connection unit 202 is controlled.

The transfer management unit 270 manages the 8-to-8 cross bar device 268. Specifically, the transfer management unit 270 determines the signal lines of the bus side connection unit 202 to which the buffers 260 to 267 are connected. Further, according to the instruction from the command management unit 250, the transfer management unit 270 controls the timing of data transmission to the reception module side connection unit 200 from the buffers 260 to 267.

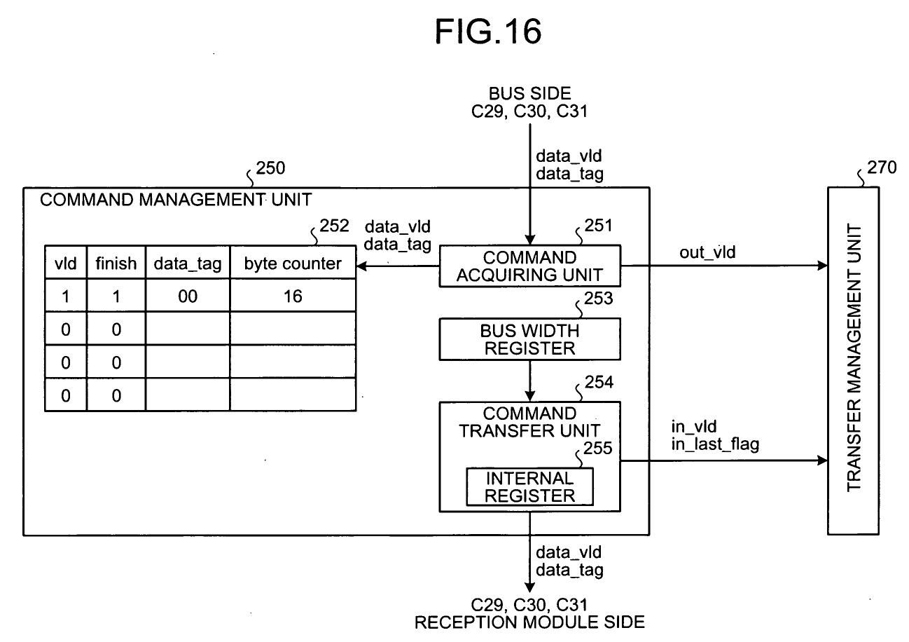

As shown in FIG. 16, the command management unit 250 includes a command acquiring unit 251, a byte counter table 252, a bus width register 253, and a command transfer unit 254. The command transfer unit 254 has an internal register 255.

The command acquiring unit 251 monitors the data_vld signal and the data_tag signal flowing in C29 to C31 and received through the bus 50. On receiving a new command, the command acquiring unit 251 registers a new entry of data transmission in the byte counter table 252. Further, the command acquiring unit 251 transmits the out_vld signal to the transfer management unit 270 while registering the new entry.

The byte counter table 252 has a vld field, a finish field, a data_tag field, and a byte counter field. The value of the vld field changes from 0 to 1 when the object entry is being processed. The value of the finish field changes from 0 to 1 when the processing of the object entry is finished. In the data_tag field, tag ID of data is stored. In the byte counter field, the data size is stored.

In the bus width register 253, the bus width of burst transfer is held. The bus width is preset according to the number of defective signal lines in the bus 50. The bus width setting method is described later.

The command transfer unit 254 monitors the byte counter table 252 and increments the value of the internal register 255 in every cycle each by the bus width stored in the bus width register 253. By referring to the byte counter table 252 and the internal register 255, the command transfer unit 254 instructs the transfer management unit 270 to perform data transfer.

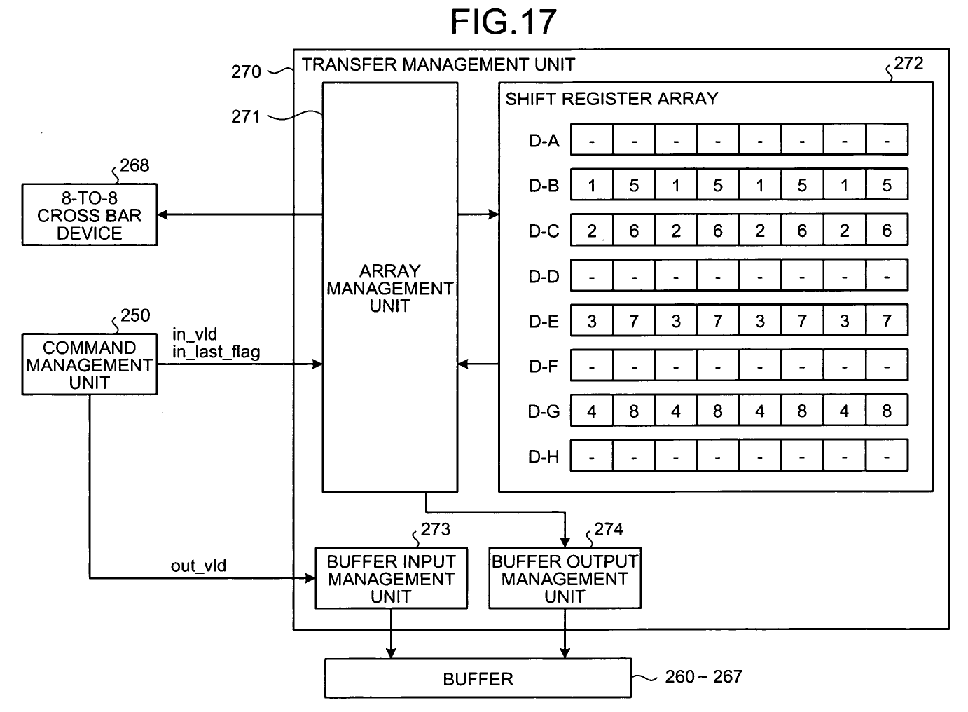

As shown in FIG. 17, the transfer management unit 270 includes an array management unit 271, a shift register array 272, a buffer input management unit 273, and a buffer output management unit 274. The array management unit 271, on receiving the in_vld signal from the command management unit 250, refers to the shift register array 272, and instructs the 8-to-8 cross bar device 268 to connect a specified buffer with a specified D group in the bus side connection unit 202. The shift register array 272 has eight shift registers corresponding to D-A to D-H. A buffer number is stored preliminarily in each shift register.

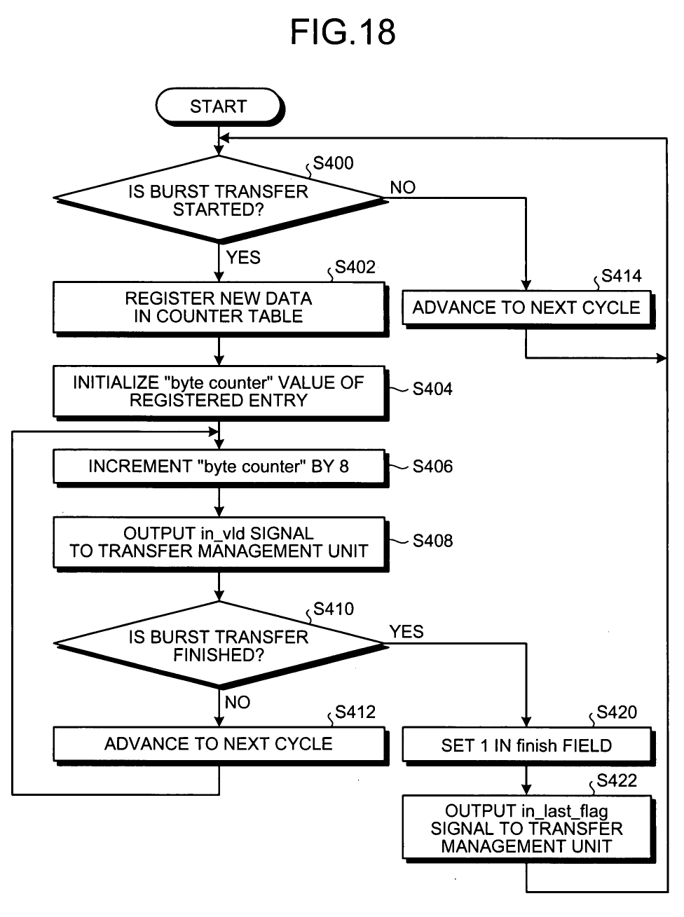

In “dynamic signal line changing phase at the time of operation of the device”, a reception process of the signal transmitted from the transmission module 30 through the bus 50 is executed. In the reception process, as shown in FIG. 18, when burst transfer is started (Yes at step S400), new data is registered in the byte counter table 252 (step s402). In the tag field, the value of the data_tag signal is registered. Next, the value of byte counter of the corresponding entry is initialized to 0 (step S404).

When the data_vld signal is 1 and the data_tag signal is of the same value, the same data is in the process of burst transfer. In this period, therefore, the command acquiring unit 251 increments the value of byte counter of the corresponding entry by 8 each in every cycle (step S406). In this cycle, the in_vld signal is sent out to the transfer management unit 270. That is, “1” is asserted (step S408).

The buffer input management unit 273 of the transfer management unit 270, on receiving the in_vld signal, stores the corresponding data in the buffers 260 to 267.

Next, when the data_vld signal is changed from 1 to 0, it is determined that burst transfer of corresponding data is finished (Yes at step S410), and the increment of the byte counter of this entry is terminated. As explained in the first embodiment, when the data_tag signal is changed from a value corresponding to specified data to a value corresponding to other data, it is also determined that the burst transfer is terminated. Next, “1” is set in the finish field of the byte counter table 252 (step S420). The in_last_flg signal is transmitted to the transfer management unit 270. That is, “1” is asserted (step S422). Back to step S400, the process waits until next burst transfer is started (step S400).

When the burst transfer is not finished (No at step S410), the process advances to next cycle (step S412), and returns to step S406.

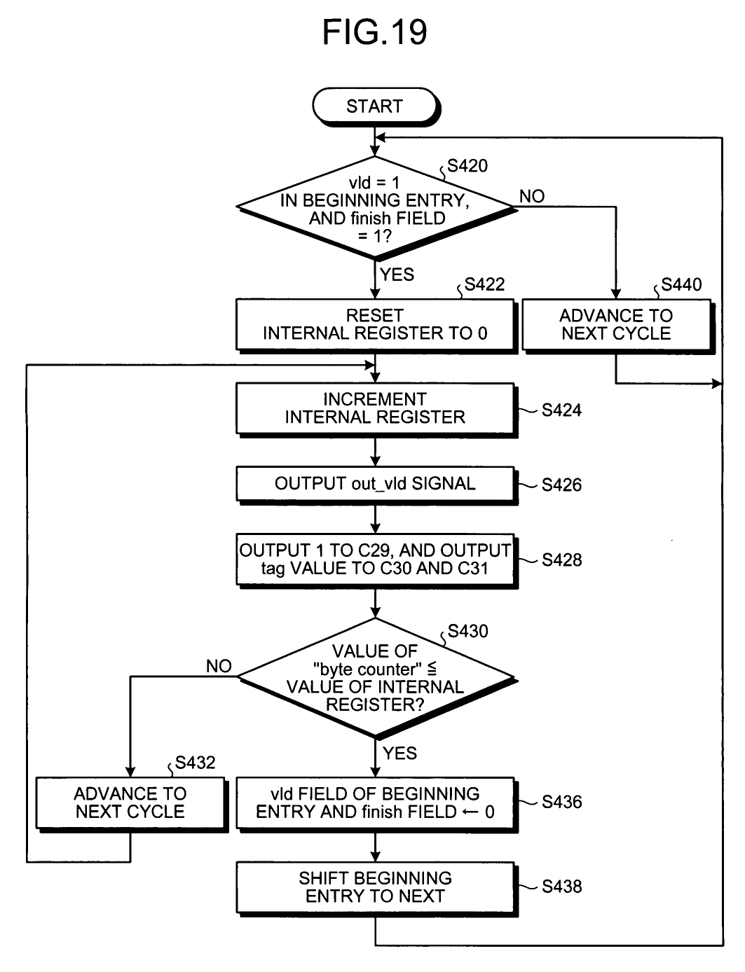

Further, in “dynamic signal line changing phase at the time of operation of the device”, the data received from the bus 50 is transmitted to the reception module 40. In this process, as shown in FIG. 19, the command transfer unit 254 starts sending out the data indicated by tag ID shown in corresponding data_tag signal to the reception module 40 when the vld field at the beginning entry of byte counter table 252 changes from 0 to 1, and the finish field of the beginning entry is 1 (Yes at step S420).

Specifically, the value of the internal register 255 is reset to 0 (step S422). Thereafter, the value of the internal register 255 is incremented by the value stored in the bus width register 253 in every cycle (step S424). In this period, the out_vld signal is output to the transfer management unit 270. That is, “1” is asserted (step S426). Further, “1” is output to C29, and the tag ID is output to C30, C31 (step S428). The timing of outputting “1” to C29 and outputting the tag ID to C30, C31 is controlled to be the same as the timing of outputting data to the reception module side connection unit 200 from the buffers 260 to 267.

The same process is continued until the value of the internal register 255 becomes equal to or higher than the value of the byte counter of the byte counter table 252. That is, if the value of the internal register 255 is less than the value of the byte counter of the byte counter table 252 (No at step S430), transfer of data identified by the tag ID is not completed, and the process advances to next cycle (step S432), and the value of the internal register 255 is incremented again by the value of the bus width register 253 (step S424), and the process advances to step S426.

When the value of the internal register 255 becomes equal to or higher than the value of the byte counter of the byte counter table 252 (Yes at step S430), transfer of data identified by the tag ID is completed, and the output of the out_last_flag signal to the transfer management unit 270 is finished in the next cycle.

Simultaneously with this process, the vld field and the finish field of the entry, which is presently being processed, out of the byte counter table 252 are set to 0, and the incrementing is stopped (step S436). Further, the beginning entry of the byte counter table 252 is moved to next entry (step S438).

The “next entry” means the entry corresponding to the data received from the bus 50 next to the data transferred immediately before. If the entry of the data transferred immediately before is the final entry of the table, the next entry is the beginning entry. Thereafter, when the vld field of the next entry is 1, the command transfer unit 254 operates the transfer of the data indicated by the tag ID to the reception module 40 in the same procedure as explained above.

Also, in “dynamic signal line changing phase at the time of operation of the device”, the transfer management unit 270 performs a reception process. In the reception process, according to the instruction from the command management unit 250, the data received from the 8-to-8 cross bar device 268 is stored in a specified buffer out of the buffers 260 to 267 in every cycle.

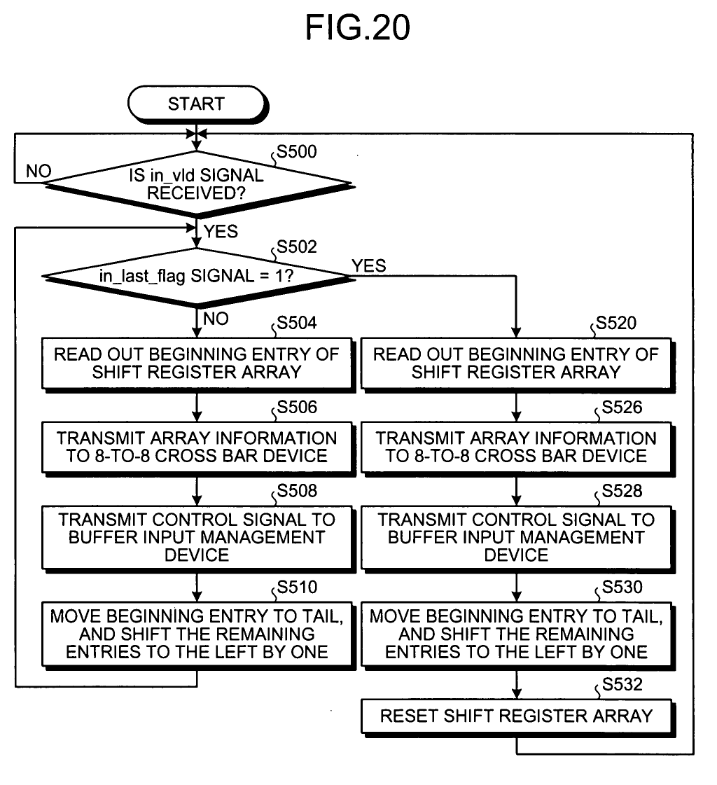

Specifically, as shown in FIG. 20, when the array management unit 271 receives the in_vld signal from the command management unit 2S0 (Yes at step S500), the reception process is started. Next, it is checked if the in_last_flag signal is 0 or 1. When data transfer is completed, the in_last_flag signal is changed from 0 to 1.

When the in_last_flag signal is 0, that is, when the data transfer is in process (No at S502), eight beginning entries of the shift register array 272 are read out (step S504). Array information indicating the values of the beginning entries which has been read out is transmitted to the 8-to-8 cross bar device 268 (step S506). To control data writing to the buffers 260 to 267 indicated by the array information, a control signal is transmitted to the buffer input management unit 273 (step S508).

When receiving the array information, the 8-to-8 cross bar device 268 connects the buffers 260 to 267 to the D groups of the bus 50 side according to the array information. Next, the beginning entry is moved to the tail, and the remaining entries are shifted by one to the left (to the beginning side) (step S510). The process returns to step S502.

In this manner, even if there is defect in the data signal line or the command signal line of the bus 50, data can be transferred by using only the usable signal lines for data transfer out of the data signal lines of the bus 50.

On the other hand, when the in_last_flag signal is 1, that is, when the data transfer is finished (Yes at S502), eight beginning entries of the shift register array 272 are read out (step S520).

The value of beginning entry is masked. That is, the buffer number is changed to “−”, and is invalidated. Specifically, it is checked if the value of the beginning entry is “8” or not sequentially from D-A to D-H. When the value of “8” is found, all values of the subsequent beginning entries are changed to “−”. The array information indicating the value of beginning entry after masking is transmitted to the 8-to-8 cross bar device 268 (step S526).

To control the writing of the buffers 260 to 267 indicated by the array information, a control signal is transmitted to the buffer input management unit 273 (step S528). Next, the array management unit 271 moves the beginning entry to the tail, and shifts the remaining entries by one to the left (step S530).

Further, the array management unit 271 resets the shift register array 272 (step S532). Specifically, the array management unit 271 has a 3-bit saturation counter not shown, and counts the number of times of the in_vld signal by the 3-bit saturation counter, counting 0 as an initial value. When the in_last_flag signal is received, the shift register array 272 is shifted by one to the left until the count value becomes 0 again. The beginning entry is moved to the tail. After resetting of the shift register array 272, the process waits until receiving the in_vld signal at step S500 again.

Thus, by monitoring the timing of data transfer and by performing the burst transfer using only the usable data signal lines, the command and the data can be transmitted securely even if there is a defect in the bus 50.

Procedure of transfer of 128-bit data when the buffer numbers shown in FIG. 17 are set in the shift register array 272 due to defects occurring in C1, C26, D0, D28, D39, and D51 is specifically described below. In this case, when the array management unit 271 receives the in_vld signal (Yes at S500), the beginning entry of the shift register array 272 is read out (step S504). The array information defining the correspondence between D-B, D-C, D-E, D-H and the buffer numbers 1 to 4 is transmitted to the 8-to-8 cross bar device 268 (step S506).

The 8-to-8 cross bar device 268 connects, based on the array information, the bus 50 side D-B, D-C, D-E, D-H to the buffers 260 to 263 identified by the buffer numbers 1 to 4, respectively. As a result, the data received from the bus 50 is stored in the buffers 260 to 263.

In the shift register array 272, the entries are shifted to the left by one (step S510). As a result, the beginning entry is moved to the tail, and the second entry from the left in FIG. 17 becomes the beginning entry. By repeating the processes from step S502 to step S510, data of three cycles is transferred, and the next cycle becomes the final cycle. The array management unit 271 receives the in_last_flag signal together with the in_vld signal.

The beginning entry of the shift register array 272 is read out (step S520). The array information defining the correspondence between D-B, D-C, D-E, D-H and the buffer numbers 5 to 8 is transmitted to the 8-to-8 cross bar device 268 (step S526).

The 8-to-8 cross bar device 268 connects, based on the array information, the bus 50 side D-B, D-C, D-E, D-H to the buffers 264 to 267 identified by the buffer numbers 5 to 8. The data received from the bus 50 is stored in the buffers 264 to 267. In this way, the data usually transferred in one cycle is divided into two portions, and transferred in two cycles, and all data can be transferred.

In the shift register array 272, the entries are shifted to the left by one (step S530). As a result, the beginning entry is moved to the tail, and the fifth entry from the left in FIG. 17 becomes the beginning entry. By this process, transfer of the data of 128 bits is completed.

Next, the array management unit 271 resets the shift register array 272 (step S532). In this case, since the entries are shifted to the left by four, the shift register array 272 is returned to the original state by moving to the left by four.

After the above process, data of four cycles is stored in the buffers 260 to 267. The buffer output management unit 274 transmits the data in two cycles to the reception module side connection unit 200. As a result, the reception module 40 receives data of 64 bits per cycle.

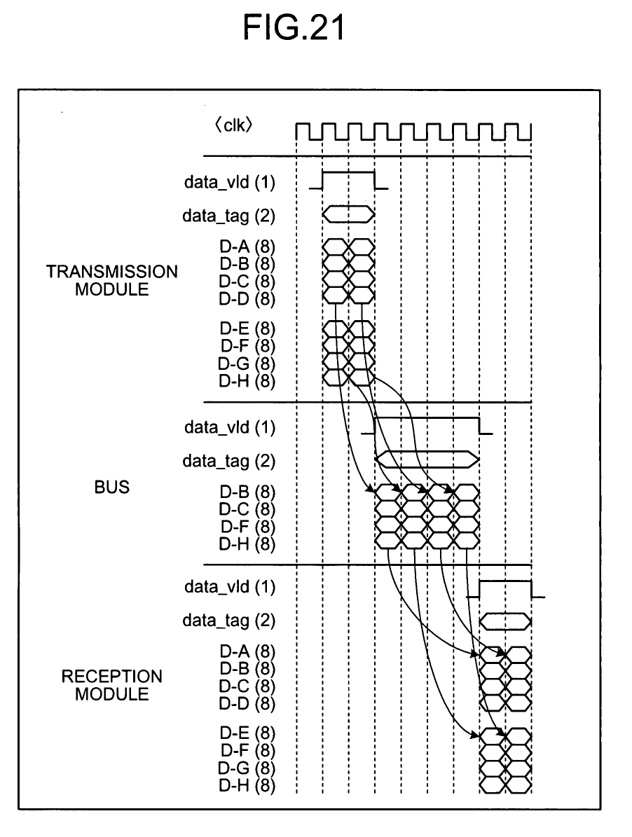

As described herein, due to a defect in the bus 50, the command management unit 250 and the transfer management unit 270 operate according to the values set in the bus width register 253 and the shift register array 272. Therefore, as shown in FIG. 21, the data of 64 bits×2 cycles transmitted from the transmission module 30 based on the assumption that the bus 50 does not have defective signal lines is sent out to the bus 50 as data of 32 bits×4 cycles in the transmission control device 10. The reception control device 20 can restore the data of 32 bits×4 cycles into data of 64 bits×2 cycles, and transmits the resulting data to the reception module 40.

Other structure and operation of the reception control device 20 are the same as those of the transmission control device 10.

The preferred embodiments of the invention are described above, and the embodiments may be modified or improved in various forms.

In a modification, for instance, a redundant signal line not used for data transfer may be provided in the bus. In this case, when the number of defective signal lines is equal to or smaller than the number of redundant signal lines, the redundant signal lines are used. When the number of defective signal lines is larger than the number of redundant signal lines, data is transferred with the use of the specified D group as explained in the first embodiment.

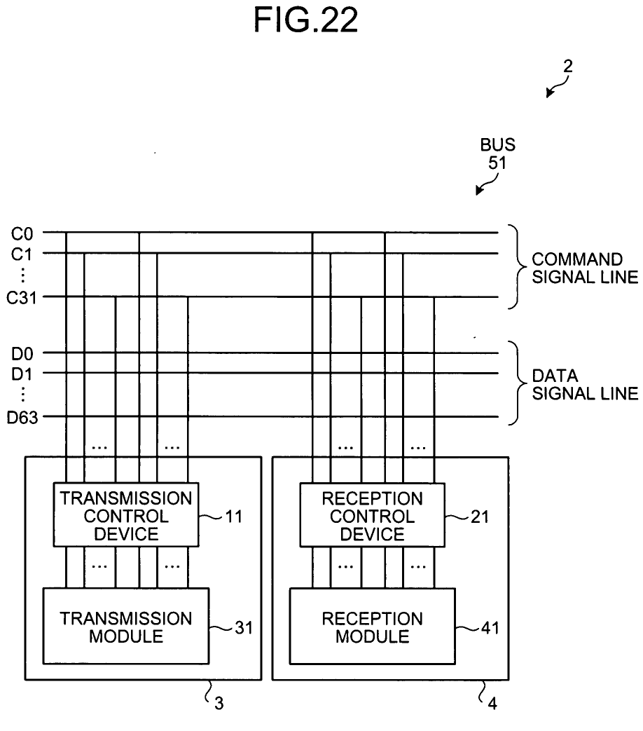

As shown in FIG. 22, in a bus system 2 of the second embodiment, a first LSI 3 has a transmission control device 11 and a transmission module 31. A second LSI 4 has a reception control device 21 and a reception module 41. The transmission control device 11 of the first LSI 3 and the reception control device 12 of the second LSI 4 are connected by a bus 51.

In this way, by providing the transmission control device 11 and the reception control device 12 in separate LSIs, data can be securely transferred even when defects occur to the signal line of the bus between the LSIs.

Other structure and operation of the bus system 2 in the second embodiment are the same as those of the LSI 1 in the first embodiment.

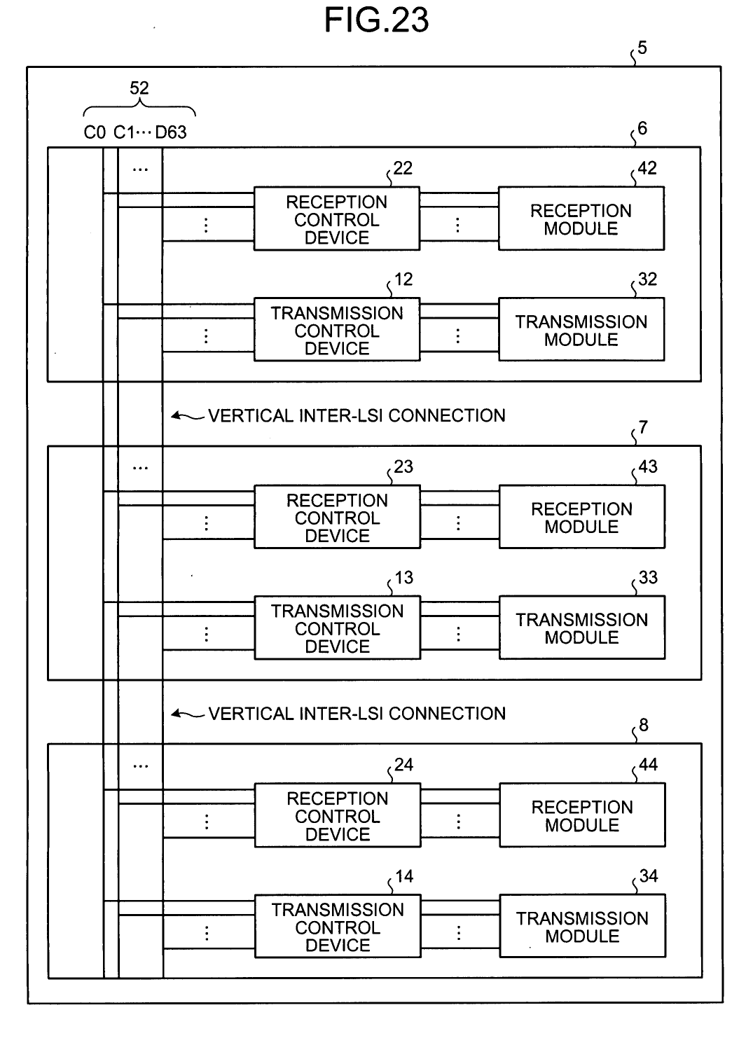

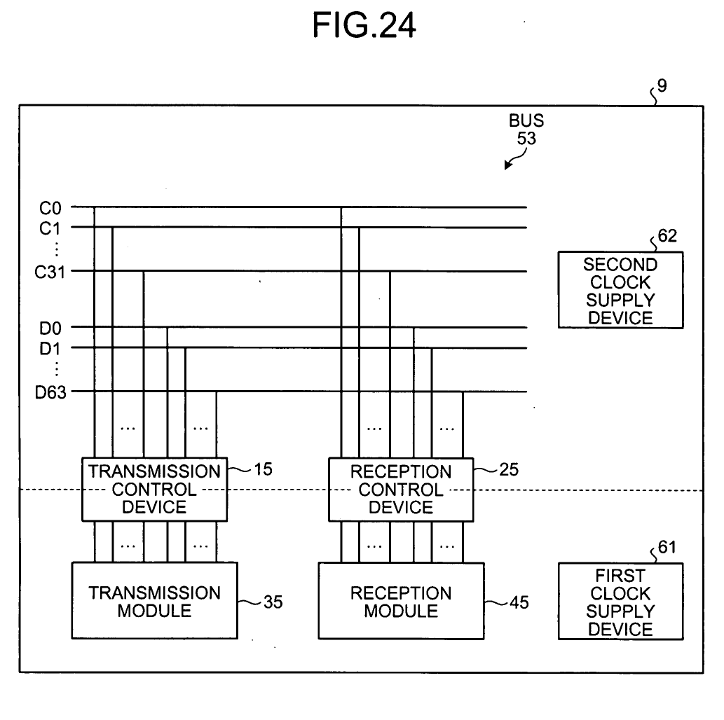

In a third embodiment, the LSIs of the first embodiment may be installed in a same package by a three-dimensional lamination method. FIG. 23 is a sectional view of a package 5 seen from a horizontal direction of the LSI. As shown in FIG. 23, the package 5 of the third embodiment has three LSIs 6 to 8. The LSIs 6 to 8 are laminated three-dimensionally by SiP technology. Wiring is connected so as to connect a bus 52 to the LSIs 6 to 8 in vertical direction. Structure and operation of the LSIs 6 to 8 are the same as those of the LSI 1 of the first embodiment.

The vertical arrangement of the wiring can shorten the wiring length in comparison with the horizontal arrangement in which the LSIs 6 to 8 are horizontally aligned and connected by horizontal wiring. Accordingly, speed-up of LSI communication is possible.

When a plurality of LSIs are installed in the same package by three-dimensional lamination method, troubles are likely to occur when connecting between the LSIs. Once laminated, even if defects are found, it is hard to repair the defects. In contrast, in the LSIs 6 to 8 of this embodiment, if a defect occurs in the bus 52, only normal signal lines without defect can be used, and data can be transferred.

An LSI 9 of a fourth embodiment has a first clock supply device 61 and a second clock supply device 62. In the LSI 9 of the fourth embodiment, if the bus performance is lowered as a result of avoiding a defect in a part of the signal lines of a bus 53, the bus performance is compensated for by increasing the operation clock of the bus 53.

Specifically, the first clock supply device 61 and the second clock supply device 62 are operated at different frequencies. A transmission control device 15, a reception control device 25, a transmission module 35, a reception module 45, and the bus 53 are divided into two clock domains. The bus 53 operates on the second clock supply device 62. Process related to data transfer between the bus 53 and the transmission control device 15 and the reception control device 25 is operated according to the clock signal of the second clock supply device 62. These processes are included in the same clock domain.

On the other hand, the transmission module 35 and the reception module 45 operate according to the clock signal of the first clock supply device 61. Process related to data transfer between the transmission module 35 and the transmission control device 15 and between the reception module 45 and the reception control device 25 is operated according to the clock signal of the first clock supply device 61.

The second clock supply device 62 has an internal register, and by changing its value, the clock frequency can be changed.

For example, when the signal lines of the bus 53 are free from defects, the value of the internal register in the second clock supply device 62 is set so that the two clock supply devices 61, 62 generate the same frequency.

If one D group out of eight D groups cannot be used in data transfer, a clock frequency of 8/7 times of clock frequency of the first clock supply device 61 is set in the internal register of the second clock supply device 62. If two D groups cannot be used in data transfer, a clock frequency of 8/6 times of clock frequency of the first clock supply device 61 is set in the internal register of the second clock supply device 62. That is, if n D groups cannot be used in data transfer, a clock frequency of 8/n (n=1 to 8) times of clock frequency of the first clock supply device 61 is set in the internal register of the second clock supply device 62.

Thus, because the clock frequency of the bus 53 side is increased corresponding to the decreased number of signal lines usable for data transfer, deterioration of performance is avoided, and defects of signal lines in the bus 53 can be avoided.

Other structure and operation of the LSI 9 in the fourth embodiment are the same as those of the LSIs in the other embodiments.

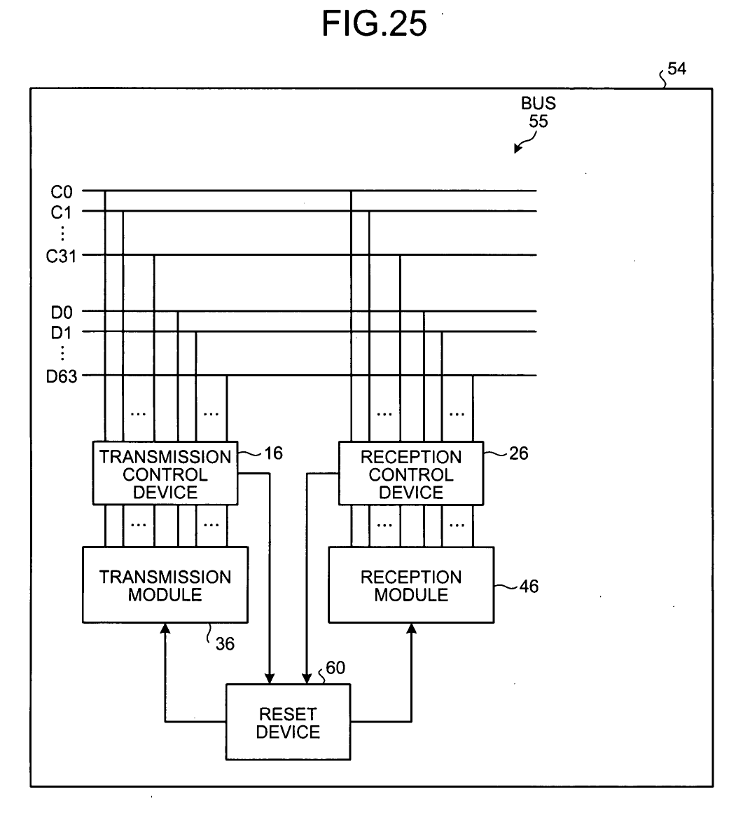

As shown in FIG. 25, an LSI 54 in a fifth embodiment has a reset device 60. A transmission control device 16 and a reception control device 26 periodically execute a defective signal detecting process. Every time the defective signal detecting process is executed, the reset device 60 updates the values in the bus width register 153 and the shift register array 172.

Other structure and operation of the LSI 54 in the fifth embodiment are the same as those of the LSIs in the other embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A transfer control device arranged between a bus and a bus interface, comprising:
a bus connecting unit that is connected to plural signal lines of the bus,
an interface connecting unit that is connected to plural signal lines of the bus interface, and
a connection control unit that connects, when a defective signal line exists in the plural signal lines of the bus, a signal line corresponding to the defective signal line out of the plural signal lines of the bus interface and a signal line other than the defective signal line out of the plural signal lines of the bus.

2. The device according to claim 1, wherein
the plural signal lines of the bus include data signal lines for transferring data, and command signal lines for transferring control command for transferring the data, and
the connection control unit connects, when a defective signal line exists in the plural signal lines of the bus, a signal line corresponding to the defective signal line out of the plural signal lines of the bus interface and a data signal line other than the defective signal line out of the plural signal lines of the bus.

3. The device according to claim 1, further comprising:
a first holding unit that holds a transfer width in burst transfer to the bus, the transfer width being determined depending on the number of the defective signal lines, and
a transfer unit that performs burst transfer to the bus in the transfer width.

4. The device according to claim 3, further comprising:
a detecting unit that detects a defective signal line of the bus, and
a first determining unit that determines the transfer width in burst transfer to the bus based on the number of the defective signal lines,
wherein the first holding unit holds the transfer width determined by the first determining unit.

5. The device according to claim 3, further comprising:
a second holding unit that holds signal line information which specifies a signal line of the bus,
wherein the transfer unit performs the burst transfer using the signal line indicated by the signal line information.

6. The device according to claim 5, further comprising:
a detecting unit that detects the defective signal line of the bus,
a second determining unit that determines a signal line other than the defective signal line as a signal line to be used in the burst transfer to the bus,
wherein the second holding unit holds the signal line information which specifies the signal line determined by the second determining unit.

7. The device according to claim 6,
wherein the second determining unit determines a data signal line other than the defective signal line as the signal line to be used in the burst transfer to the bus.

8. A large-scale integration (LSI) having a bus interface connected to a bus, and a transfer control device connected between the bus and the bus interface, wherein
the transfer control device includes:
a bus connecting unit that is connected to plural signal lines of the bus,
an interface connecting unit that is connected to plural signal lines of the bus interface, and
a connection control unit that connects, when a defective signal line exists in the plural signal lines of the bus, a signal line corresponding to the defective signal line out of the plural signal lines of the bus interface and a signal line other than the defective signal line out of the plural signal lines of the bus.

9. The LSI according to claim 8, further comprising:
a first clock unit that supplies a first clock frequency to the bus interface and the interface connecting unit of the transfer control device, and
a second clock unit that supplies a second clock frequency determined according to the first clock frequency and the number of defective signal lines.

10. The LSI according to claim 8,
wherein the plural signal lines the bus include data signal lines for transferring data, and command signal lines for transferring control command for transferring the data, and
the connection control unit connects, when a defective signal line exists in the plural signal lines of the bus, a signal line corresponding to the defective signal line out of the plural signal lines of the bus interface and a data signal line other than the defective signal line out of the plural signal lines of the bus.

11. The LSI according to claim 8, further comprising:
a first holding unit that holds a transfer width in burst transfer to the bus, the transfer width being determined depending on the number of the defective signal lines, and
a transfer unit that performs burst transfer to the bus in the transfer width.

12. The LSI according to claim 11, further comprising:
a detecting unit that detects a defective signal line of the bus, and
a first determining unit that determines the transfer width in burst transfer to the bus based on the number of the defective signal lines,
wherein the first holding unit holds the transfer width determined by the first determining unit.

13. The LSI according to claim 11, further comprising:
a second holding unit that holds signal line information which specifies a signal line of the bus to be used in the burst transfer,
wherein the transfer unit performs the burst transfer using the signal line indicated by the signal line information.

14. The LSI according to claim 11, further comprising:
a detecting unit that detects the defective signal line of the bus,
a second determining unit that determines a signal line other than the defective signal line as a signal line to be used in the burst transfer to the bus,
wherein the second holding unit holds the signal line information which specifies the signal line determined by the second determining unit.

15. A package having plural LSIs laminated in a vertical direction of the LSIs and connected through a bus,
wherein each of the plural LSIs has a bus interface connected to the bus, and a transfer control device connected between the bus and the bus interface, and
the transfer control device includes
a bus connecting unit that is connected to plural signal lines of the bus,
an interface connecting unit that is connected to plural signal lines of the bus interface, and
a connection control unit that connects, when a defective signal line exists in the plural signal lines of the bus, a signal line corresponding to the defective signal line out of the plural signal lines of the bus interface and a signal line other than the defective signal line out of the plural signal lines of the bus.

16. The package according to claim 15,
wherein the plural signal lines of the bus include data signal lines for transferring data, and command signal lines for transferring control command for transferring the data, and
the connection control unit connects, when a defective signal line exits in the plural signal lines of the bus, a signal line corresponding to the defective signal line out of the plural signal lines of the bus interface and a data signal line other than the defective signal line out of the plural signal lines of the bus.

17. The package according to claim 15, further comprising:
a first holding unit that holds a transfer width in burst transfer to the bus, the transfer width being determined depending on the number of the defective signal lines, and
a transfer unit that performs burst transfer to the bus in the transfer width.

18. The package according to claim 17, further comprising:
a detecting unit that detects a defective signal line of the bus, and
a first determining unit that determines the transfer width in burst transfer to the bus based on the number of the defective signal lines,
wherein the first holding unit holds the transfer width determined by the first determining unit.

19. The package according to claim 17, further comprising:
a second holding unit that holds signal line information which specifies a signal line of the bus to be used in the burst transfer,
wherein the transfer unit performs the burst transfer using the signal line indicated by the signal line information.

20. The package according to claim 19, further comprising:
a detecting unit that detects the defective signal line of the bus,
a second determining unit that determines a signal line other than the defective signal line as a signal line to be used in the burst transfer to the bus,
wherein the second holding unit holds the signal line information which specifies the signal line determined by the second determining unit.
